(19) United States
(12) Patent Application Publication
(10) Pub. No.: US 2006/0264529 A1
(43) Pub. Date: Nov. 23, 2006

(54) ACTIVE ENERGY RAY CURABLE COMPOSITION

(75) Inventor: Nobumasa SASA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 11/460,802

(22) Filed: Jul. 28, 2006

Related U.S. Application Data
(62) Division of application No. 10/774,733, filed on Feb. 9, 2004.

(30) Foreign Application Priority Data
Feb. 24, 2003 (JP) JP2003-045576
Jul. 23, 2003 (JP) JP2003-200385

(51) Int. Cl. C08J 3/28

(52) U.S. Cl. 522/170; 522/56

(57) ABSTRACT

An active energy ray curable composition containing an epoxy compound having at least one oxirane ring having substituents at positions α and β of the oxirane ring.

### CROSS REFERENCE TO RELATED APPLICATIONS

This is a Divisional of U.S. patent application Ser. No. 10/774,733 filed Feb. 9, 2004, which, in turn, claimed the priority of Japanese Patent Application Nos. JP2003-045,576 filed Feb. 24, 2003 and JP2003-200,385 filed Jul. 23, 2003, the priority of all three applications is hereby claimed and all three applications are hereby incorporated herein by reference.

### BACKGROUND OF THE INVENTION

1. Field of the Invention

The present invention relates to an active energy ray curable composition. In particular, the invention relates to an active energy curable composition used for inkjet inks, printing inks, coating paints for cans, plastics, paper, woods and the like, adhesives, phototyping three dimensional modelling and the like.

2. Description of Related Art

Conventionally, as inkjet inks with good water resistance, there are those in which oil soluble dyes are dispersed or dissolved in a solvent with a high boiling point and those in which oil soluble dyes are dissolved in a volatile solvent, but since the dyes are inferior to pigments in various resistance such as light resistance, an ink using the pigment as a coloring agent has been desired. However, it is difficult to stably disperse the pigments in an organic solvent, and it is also difficult to assure stable dispersibility and jettability. Meanwhile, for the ink using the solvent with a high boiling point, since the solvent in the ink is not vaporized on an unabsorbent substrate and it is difficult to dry the solvent by evaporation, it is impossible to print on the unabsorbent substrate.

For the ink using a volatile organic solvent, it is possible to form good printing even on the unabsorbent substrate by adhesiveness of a resin used and vaporization of the solvent. However, since the volatile solvent is a major component of the ink, drying at a nozzle face of a head is extremely rapid due to vaporization of the solvent, and thus frequent maintenance is needed. Also, since resolubility for the solvent is essentially required for the ink, resistance to the solvent is not sufficiently obtained in some cases.

In an on-demand printer by piezo actuators, using the volatile solvent at a large amount increases a frequency of maintenance and easily induces a trouble that ink-contacting materials in the printer are dissolved and swell. Also, the volatile solvent is considerably restricted due to a hazardous material under the Fire Defense Law. Thus, in the on-demand printer by piezo actuators, it is necessary to use the ink with less volatile solvent. However, materials used for an active energy ray curable type ink are the materials with relatively high viscosity. At the viscosity at which jetting is possible in the conventional printer, it has been difficult to design an ink with good curability and good stability.

To solve such problems, Japanese Patent Publication (Laid-open) No. Tokukai-2001-220526 discloses an active energy ray curable type composition containing an epoxy compound and an oxetane ring-containing compound or a vinylether compound. However, as a result of studying on the epoxy compound described in the above patent, there was problematic in safety, stability, curability under high humidity and strength of cured films of the active energy ray curable type compound, and also problematic in jetting stability at nozzles, adhesiveness to substrates, solvent resistance and water resistance.

In the meantime, the above active energy curable composition is not only used for the ink for inkjet but also widely used by combining an epoxy compound, particularly an alicyclic epoxy compound with a cationic photopolymerization initiator. For example there are descriptions of the use for printing inks in Japanese Patent Publication (Laid-open) No. Tokukaihei-8-143806, the use for coating paints in Japanese Patent Publication (Laid-open) No. Tokukaihei-8-20627 and Japanese Patent Publication (Laid-open) No. Tokukaihei-10-158581, the use for coating paints on outer surfaces of cans in Japanese Patent Publication (Laid-open) No. Tokukaihei-8-134405, the use for coating paints for plastic coating in Japanese Patent Publication (Laid-open) No. Tokukaihei-8-208832, the use for coating paints for paper coating in Japanese Patent Publication (Laid-open) No. Tokukaihei-8-218296, the use for coating paints for woods in Japanese Patent Publication (Laid-open) No. Tokukaihei-8-239623, the use for adhesives in Japanese Patent Publication (Laid-open) No. Tokukaihei-8-231938 and the use for phototyping three dimensional modelling in Japanese Patent Publication (Laid-open) No. Tokukaihei-8-20728 and Japanese Patent Publication (Laid-open) No. Tokukai-2000-62030.

However, when the epoxy compounds described above patents were studied, there was problematic in safety of the epoxy compounds and the active energy ray curable compositions, stability, curability (particularly curability under high humidity), strength of cured films, solvent resistance and water resistance of the active energy ray curable compositions, and also problematic in shrinkage at the polymerization.

### SUMMARY OF THE INVENTION

An object of the present invention is to provide an active energy ray curable composition where safety and stability of an epoxy compound and the active energy ray curable composition are high, photo curability is excellent even under high humidity, strength of cured films is tough, and solvent resistance and water resistance are good.

The above object of the invention has been accomplished by the following configuration.

According to the first aspect of the invention, this active energy ray curable composition contains an epoxy compound having at least one oxirane ring having substituents at least at positions α and β of the oxirane ring.

Preferably, the above epoxy compound is represented by the following general formula (1)

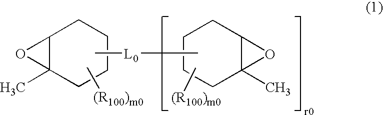

In the general formula (1), R₁₀₀ represents a substituent, m0 represents 0 to 2, r0 represents 1 to 3, and L₀ represents an r0+1 valent linkage group with 1 to 15 carbons which may comprise oxygen or sulfur atoms in a backbone, or a single bond.

Preferably, the above epoxy compound is the compound represented by the following general formula (2) or (3).

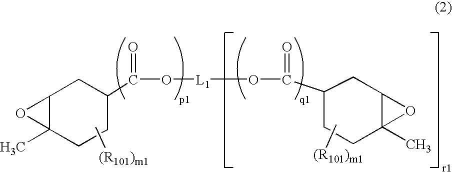

In the general formula (2), R₁₀₁ represents a substituent, m1 represents 0 to 2, p1 and q1 represent 0 or 1, respectively, and r1 represents 1 to 3. L₁ represents an r1+1 valent linkage group with 1 to 15 carbons which may comprise oxygen or sulfur atoms in a backbone, or a single bond.

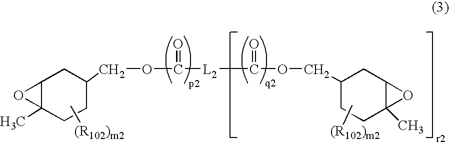

In the general formula (3), R₁₀₂ represents a substituent, m2 represents 0 to 2, p2 and q2 represent 0 or 1, respectively, and r2 represents 1 to 3. L₂ represents an r2+1 valent linkage group with 1 to 15 carbons which may comprise oxygen or sulfur atoms in a backbone, or a single bond.

Preferably, a molecular weight of the epoxy compound is from 170 to 1,000.

Preferably, the composition according to the first aspect of the invention contains either an oxetane compound or a vinylether compound.

Preferably, the composition according to the first aspect of the invention contains a cationic photopolymerization initiator.

Preferably, the composition according to the first aspect of the invention contains at least one sulfonium salt represented by the following formulae (4) to (7) as the cationic photopolymerization initiator, which does not produce benzene by irradiation of active energy ray and a compound having oxetane ring as a photopolymerizable compound.

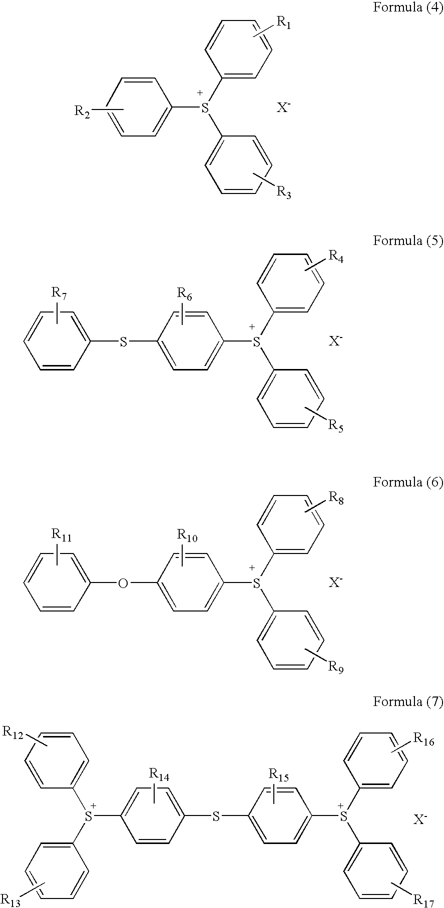

In the general formulae (4) to (7), R₁ to R₁₇ represent hydrogen atoms or substituents, R₁ to R₃ do not represent hydrogen atoms simultaneously, R₄ to R₇ do not represent hydrogen atoms simultaneously, R₈ to R₁, do not represent hydrogen atoms simultaneously, and R₁₂ to R₁₇ do not represent hydrogen atoms simultaneously. X represents a non-nucleophilic anion residue.

Preferably, the sulfonium salt represented by the above general formulae (4) to (7) is at least one of the sulfonium salts selected from the following general formulae (8) to (16).

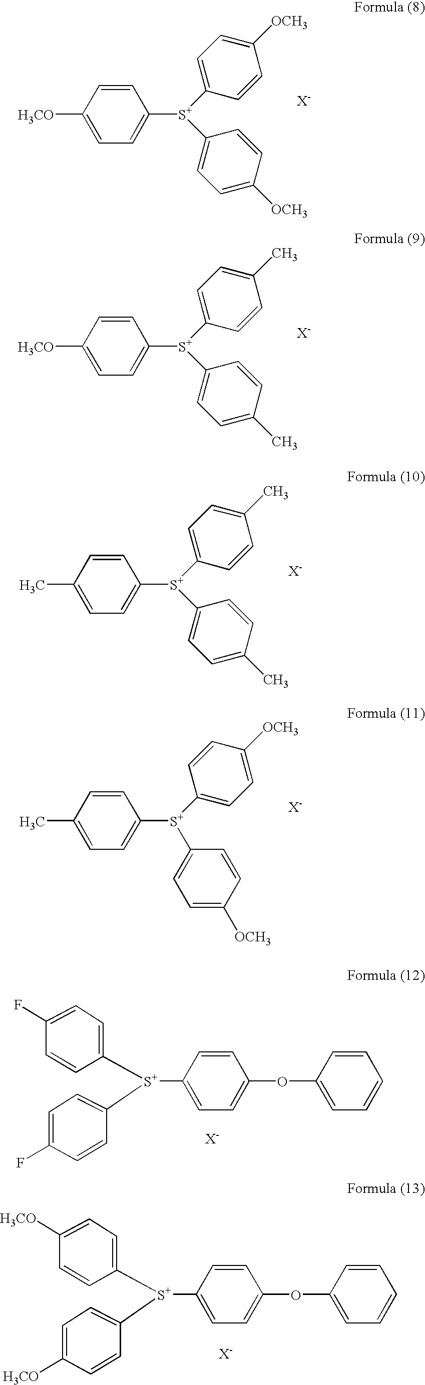

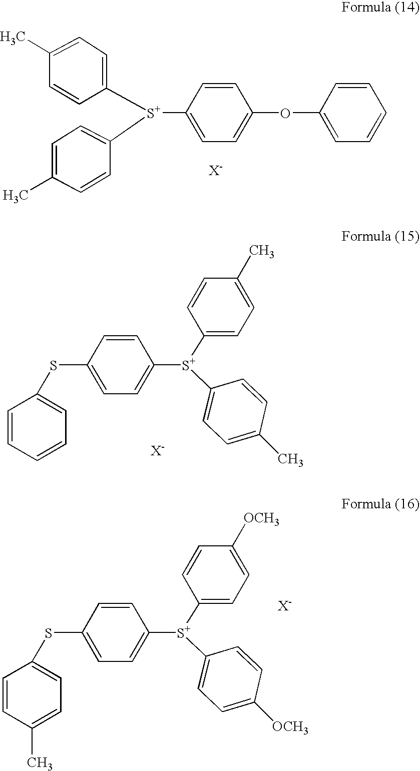

In the general formulae (8) to (16), X represents a non-nucleophilic anion residue.

Preferably, the composition according to the first aspect of the invention contains pigments.

Preferably, an average particle diameter of the pigments is from 10 to 150 nm.

Preferably, the composition according to the first aspect of the invention contains a pigment dispersant.

Preferably, in the composition according to the first aspect of the invention contains, a viscosity at 25° C. is 5 to 50 mPa·s.

According to the invention, it is possible to provide an active energy ray curable composition where safety and stability of an epoxy compound and the active energy ray curable composition are high, photo curability is excellent even under high humidity, strength of cured films is tough, and solvent resistance and water resistance are good.

### BRIEF DESCRIPTION OF THE DRAWINGS

The invention will be further appreciated by the following detailed description and the attached drawings, but these are exclusively for the illustration and do not limit the scope of the invention. Here:

FIG. 1 is an explanatory view showing a step of forming an uncured composition layer in an phototyping three dimensional modelling system;

FIG. 2 is an explanatory view showing a step of obtaining a first cured layer in an phototyping three dimensional modelling system;

FIG. 3 is an explanatory view showing a step of further forming an uncured composition layer on the first cured layer in an phototyping three dimensional modelling system; and

FIG. 4 is an explanatory view showing a step of obtaining a second cured layer in an phototyping three dimensional modelling system.

### DETAILED DESCRIPTION OF THE PREFERRED EMBODIMENT

The present invention will be described in more detail below.

The invention is an active energy ray curable composition characterized by containing an epoxy compound with a particular structure and a sulfonium salt with a particular structure. To further exhibit effects of the invention, it is preferable to comprise an oxetane compound, a vinylether compound, a cationic photopolymerization initiator, pigments and a pigment dispersant in addition thereto. Also, it is preferred that the pigments are fine pigments with an average particle diameter of 10 to 150 nm and that a viscosity at 25° C. is from 5 to 50 mPa·s in the active energy ray curable compound according to the invention.

(Epoxy Compound)

The epoxy compound used for the invention is not particularly limited as long as it is the epoxy compound having substituents at least at positions α and β of the oxirane ring, but internal epoxy compounds of which representatives are epoxylated fatty acid ester and the like are excluded.

Compound examples (example compounds 1 to 28) are shown below.

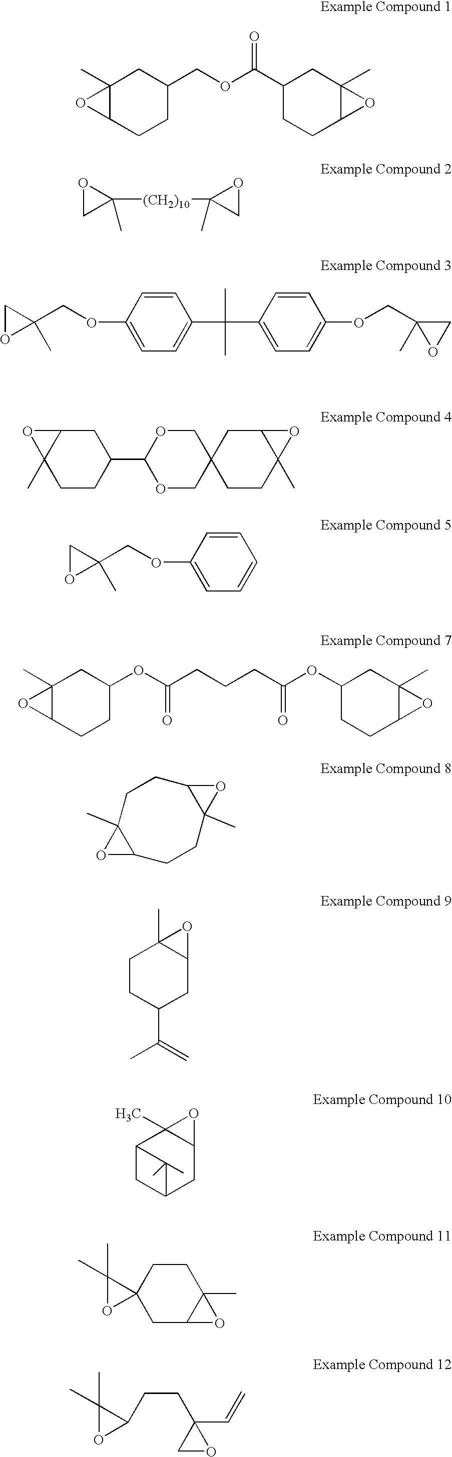

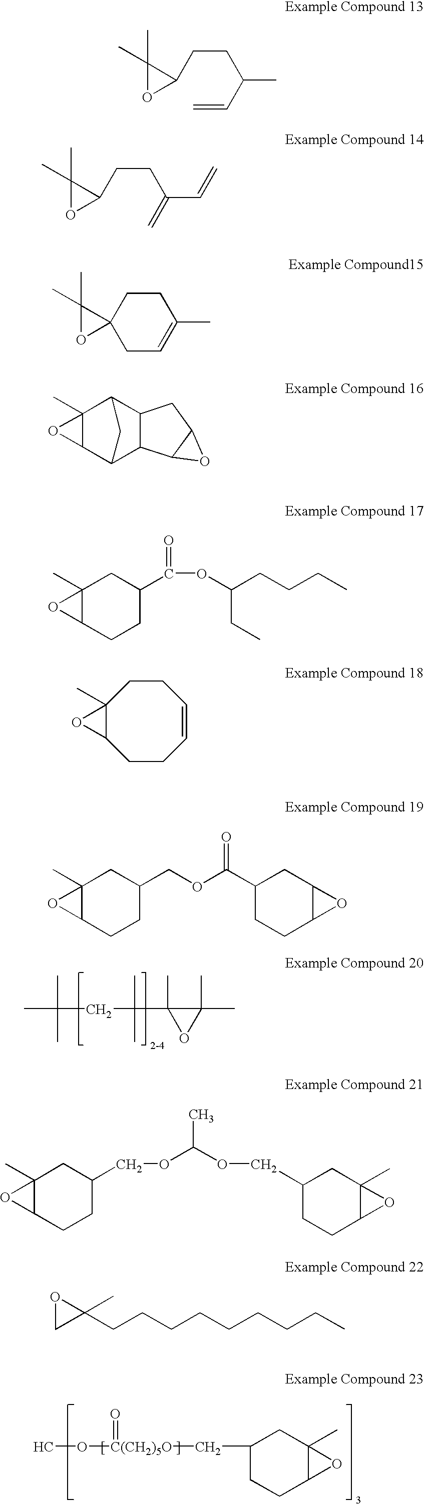

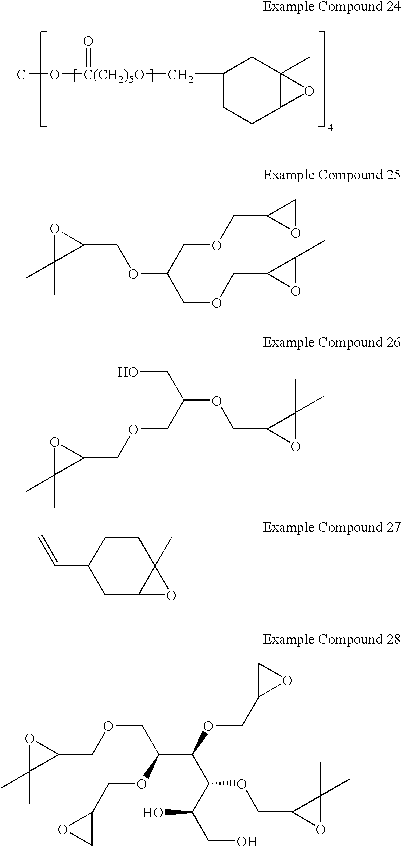

These compounds can be synthesized in reference to the following literatures.

Jikken Kagaku Kouza 20 Yuki Gosei II 4th edition, from page 213, 1992, published by Maruzen Co., Ltd.;

The Chemistry of Heterocyclic Compounds, Small Ring Heterocycles, part 3, Oxiranes, edited by Alfred Hasfner, 1985, published by John & Wiley and Sons, An Interscience Publication, New York;

Yoshimura, Secchaku, Vol. 29 No. 12:32, 1985;

Yoshimura, Secchaku, Vol. 30 No. 5:42, 1986; and

Yoshimura, Secchaku, Vol. 30 No. 7:42, 1986.

For example, concerning the example compound 1, (4-methyl-cyclohex-3-enyl)-methanol and 4-methyl-cyclohex-3-enecarbonyl chloride are synthesized by Diels-Alder reaction of 2-methyl-buta-1,3-diene with 2-propen-1-ol and acryloyl chloride, respectively and then 4-methyl-cyclohex-3-enecarboxylic acid 4-methyl-cyclohex-3-enylmethyl ester is yield by esterification thereof. Finally, double bonds are oxidized to yield 6-methyl-7-oxa-bicyclo[4.1.0]heptane-3-carboxylic acid 6-methyl-7-oxa-bicyclo[4.1.0]hept-3-ylmethyl ester.

In particular, the epoxy compounds used for the invention are represented by the above general formulae (1), (2) and (3). Those epoxy compounds are described below.

R₁₀₀, R₁₀₁ and R₁₀₂ in the above general formulae (1) to (3) represent substituents. Examples of the substituents include halogen atoms (e.g., chlorine, bromine, fluorine atoms etc.), alkyl groups with 1 to 6 carbons (e.g., methyl, ethyl, propyl, isopropyl, butyl, etc.), alkoxy groups with 1 to 6 carbons (e.g., methoxy, ethoxy, n-propoxy, iso-propoxy, n-butoxy, tert-butoxy, etc.), acyl groups (e.g., acetyl, propionyl, trifluoroacetyl, etc.), acyloxy groups (e.g., acetoxy, propionyloxy, etc.), alkoxycarbonyl groups (methoxycarbonyl, ethoxycarbonyl, tert-butoxycarbonyl, etc.) and the like. As the substituents, preferred are alkyl, alkoxy and alkoxycarbonyl groups.

And m0, m1 and m2 represent 0 to 2, and are preferably 0 or 1.

L₀ represents an r0+1 valent linkage group with 1 to 15 carbons which may comprise oxygen or sulfur atoms in a backbone, or a single bond, L₁ represents an r1+1 valent linkage group with 1 to 15 carbons which may comprise oxygen or sulfur atoms in a backbone, or a single bond and L₂ represents an r2+1 valent linkage group with 1 to 15 carbons which may comprise oxygen or sulfur atoms in a backbone, or a single bond.

Examples of bivalent linkage groups with 1 to 15 carbons which may comprise oxygen or sulfur atoms in the backbone can include the following groups, and groups made by combining these groups with multiple groups of —O—, —S—, —CO— and —CS— groups.
Methylene group [—CH₂—],
ethylidene group [>CHCH₃],
isopropylidene group [>C(CH₃)₂],
1,2-ethylene group [—CH₂CH₂—],
1,2-propylene group [—CH(CH₃)CH₂—],
1,3-propanediyl group [—CH₂CH₂CH₂—],
2,2-dimethyl-1,3-propanediyl group [—CH₂C(CH₃)₂CH₂—],
2,2-dimethoxy-1,3-propanediyl group [—CH₂C(OCH₃)₂CH₂—],
2,2-dimethoxymethyl-1,3-propanediyl group [—CH₂C(CH₂OCH₃)₂CH₂—],
1-methyl-1,3-propanediyl group [—CH(CH₃)OH₂CH₂—],
1,4-butanediyl group [—CH₂CH₂CH₂CH₂—],
1,5-pentanediyl group [—CH₂CH₂CH₂CH₂CH₂—],
oxydiethylene group [—CH₂CH₂OCH₂CH₂—],
thiodiethylene group [—CH₂CH₂SCH₂CH₂—],
3-oxothiodiethylene group [—CH₂CH₂SOCH₂CH₂—],
3,3-dioxothiodiethylene group [—CH₂CH₂SO₂CH₂CH₂—],
1,4-dimethyl-3-oxa-1,5-pentanediyl group [—CH(CH₃)CH₂CH(CH₃)CH₂—],
3-oxopentanediyl group [—CH₂CH₂COCH₂CH₂—],
1,5-dioxo-3-oxopentanediyl group [—COCH₂OCH₂CO—],
4-oxa-1,7-heptanediyl group [—CH₂CH₂CH₂OCH₂CH₂CH₂—],
3,6-dioxa-1,8-octanediyl group [—CH₂CH₂OCH₂CH₂OCH₂CH₂—],
1,4,7-trimethyl-3,6-dioxa-1,8-octanediyl group [CH(CH₃)CH₂OCH(CH₃)CH₂OCH(CH₃)CH₂—],
5,5-dimethyl-3,7-dioxa-1,9-nonanediyl group [—CH₂CH₂OCH₂C(CH₃)₂CH₂OCH₂CH₂—],
5,5-dimethoxy-3,7-dioxa-1,9-nonanediyl group [—CH₂CH₂OCH₂C(OCH₃)₂CH₂OCH₂CH₂—],
5,5-dimethoxymethyl-3,7-dioxa-1,9-nonanediyl group [—CH₂CH₂OCH₂C(CH₂OCH₃)₂CH₂OCH₂CH₂—],
4,7-dioxo-3,8-dioxa-1,10-decanediyl group [—CH₂CH₂O—COCH₂CH₂CO—OCH₂CH₂—],
3,8-dioxo-4,7-dioxa-1,10-decanediyl group [—CH₂CH₂CO—OCH₂CH₂O—COCH₂CH₂—],
1,3-cyclopentanediyl group [-1,3-C₅H₈—],
1,2-cyclohexanediyl group [-1,2-C₆H₁₀—],
1,3-cyclohexanediyl group [-1,3-C₆H₁₀—],
1,4-cyclohexanediyl group [-1,4-C₆H₁₀—],
2,5-tetrahydrofurandiyl group [2,5-C₄H₆O—],
p-phenylene group [-p-C₆H₄—],
m-phenylene group [-m-C₆H₄—],
α,α′-o-xylylene group [-o-CH₂—C₆H₄—CH₂—],
α,α′-m-xylylene group [-m-CH₂—C₆H₄—CH₂—],
α,α′-p-xylylene group [-p-CH₂—C₆H₄—CH₂—],
furan-2,5-diyl-bismethylene group [2,5—CH₂—C₄H₂O—CH₂—],
thiophene-2,5-diyl-bismethylene group [2,5—CH₂—C₄H₂S—CH₂—] and
isopropylidene bis-p-phenylene group [-p-C₆H₄—C(CH₃)₂-p-C₆H₄—].

The trivalent or more linkage groups can include groups made by subtracting hydrogen atoms at given sites as many as needed from the bivalent linkage groups included above and groups made by combining these groups with multiple groups of —O—, —S—, —CO— and —CS— groups.

L₀, L₁ and L₂ may have substituents. Examples of the substituents include halogen atoms (e.g., chlorine, bromine, fluorine atoms etc.), alkyl groups with 1 to 6 carbons (e.g., methyl, ethyl, propyl, isopropyl, butyl, etc.), alkoxy groups with 1 to 6 carbons (e.g., methoxy, ethoxy, n-propoxy, iso-propoxy, n-butoxy, tert-butoxy, etc.), acyl groups (e.g., acetyl, propionyl, trifluoroacetyl, etc.), acyloxy groups (e.g., acetoxy, propionyloxy, trifluoroacetoxy, etc.), alkoxycarbonyl groups (methoxycarbonyl, ethoxycarbonyl, tert-butoxycarbonyl, etc.) and the like. As the substituents, preferred are alkyl, alkoxy and alkoxycarbonyl groups.

As L₀, L₁ and L₂, preferable are bivalent linkage groups with 1 to 8 carbons, which may comprise oxygen or sulfur atoms in the backbone, and more preferable are bivalent linkage groups with 1 to 5 carbons, of which backbone is composed of carbon alone.

And, p1 and q1 each represent 0 or 1, and it is preferred that p1+q1 is 1 or more.

And, p2 and q2 each represent 0 or 1, and it is preferable to be 1.

Specific examples (EP-1 to EP-51) of preferable epoxy compounds are shown below, but the invention is not limited thereto.

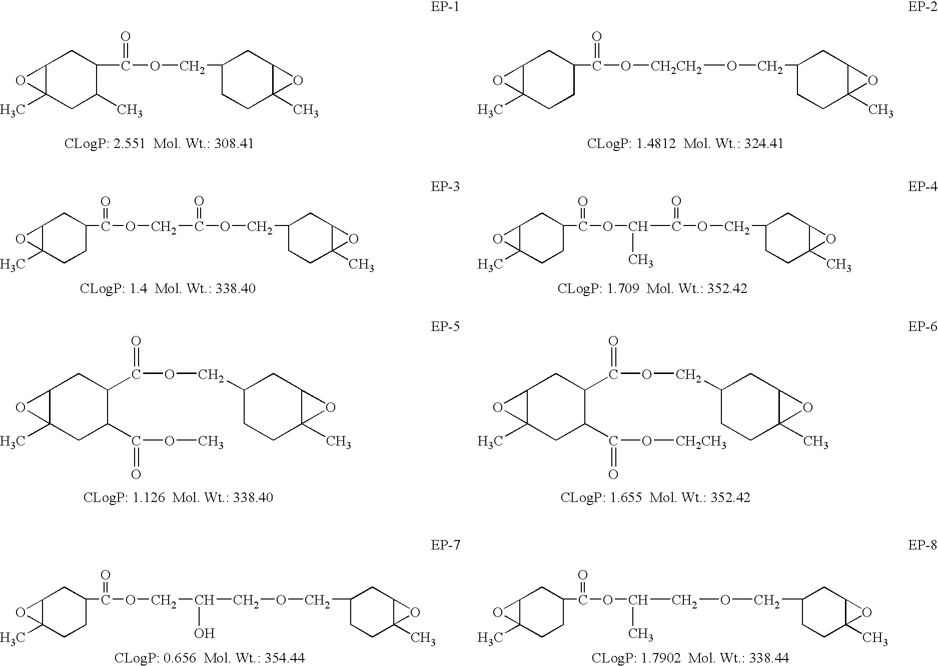

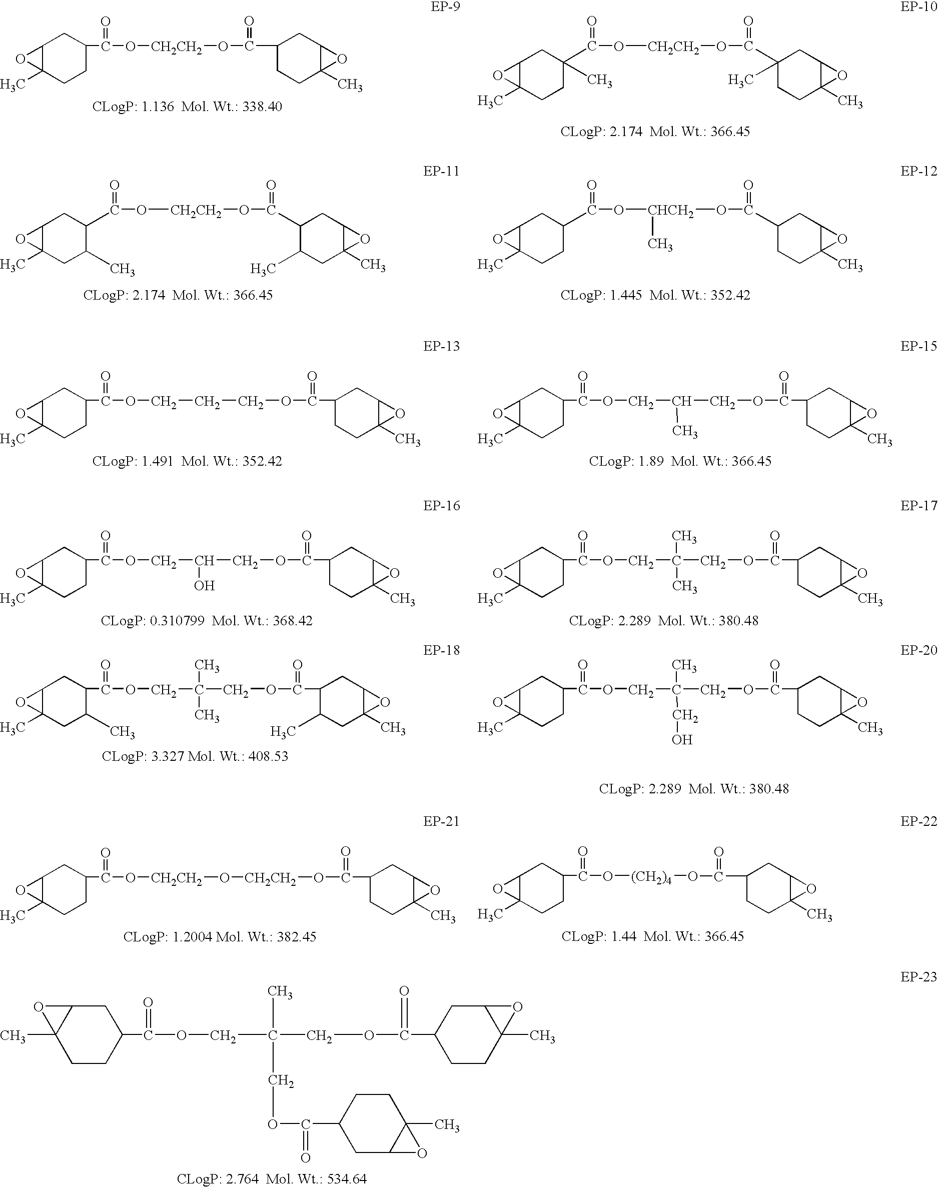

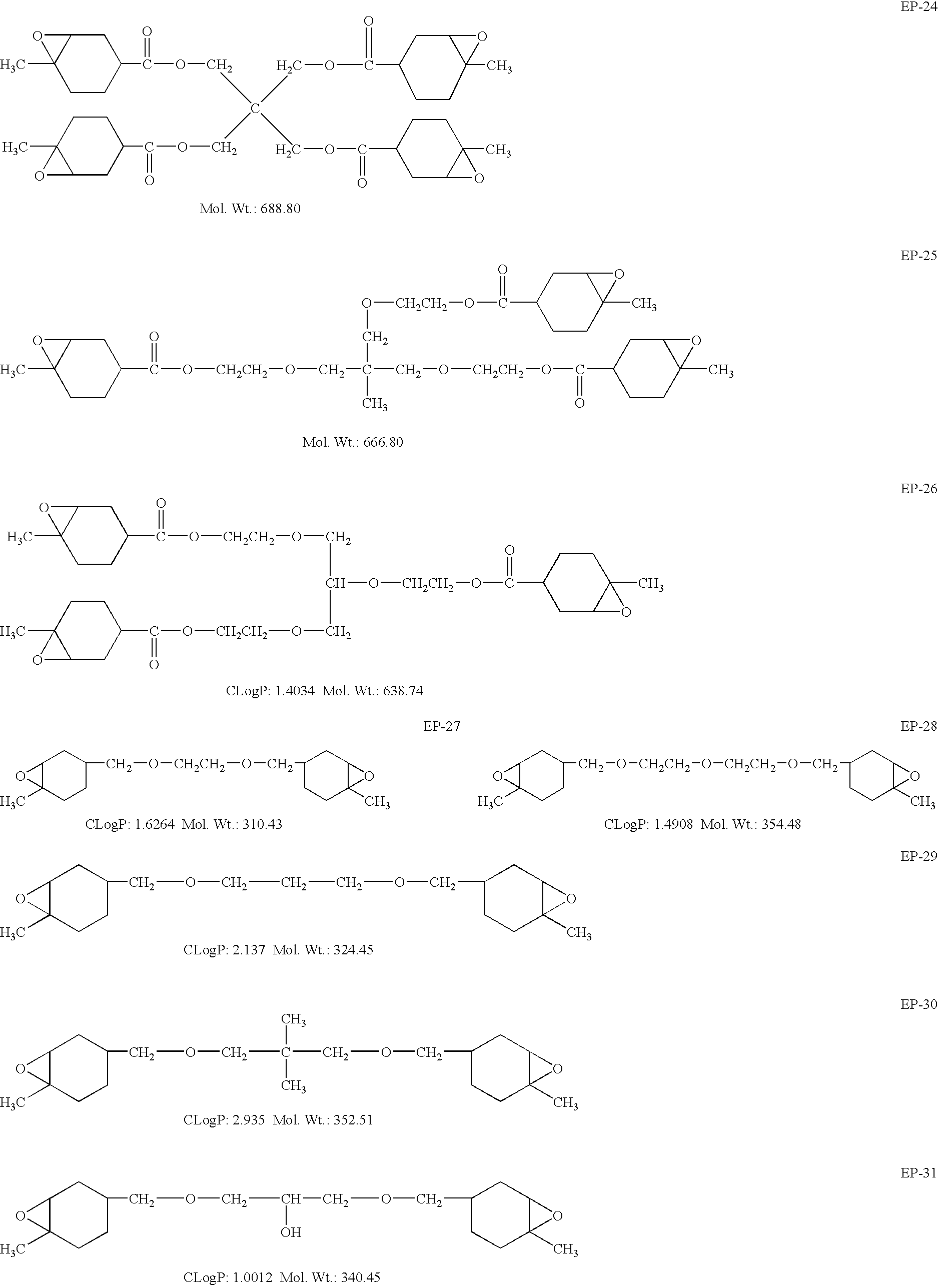

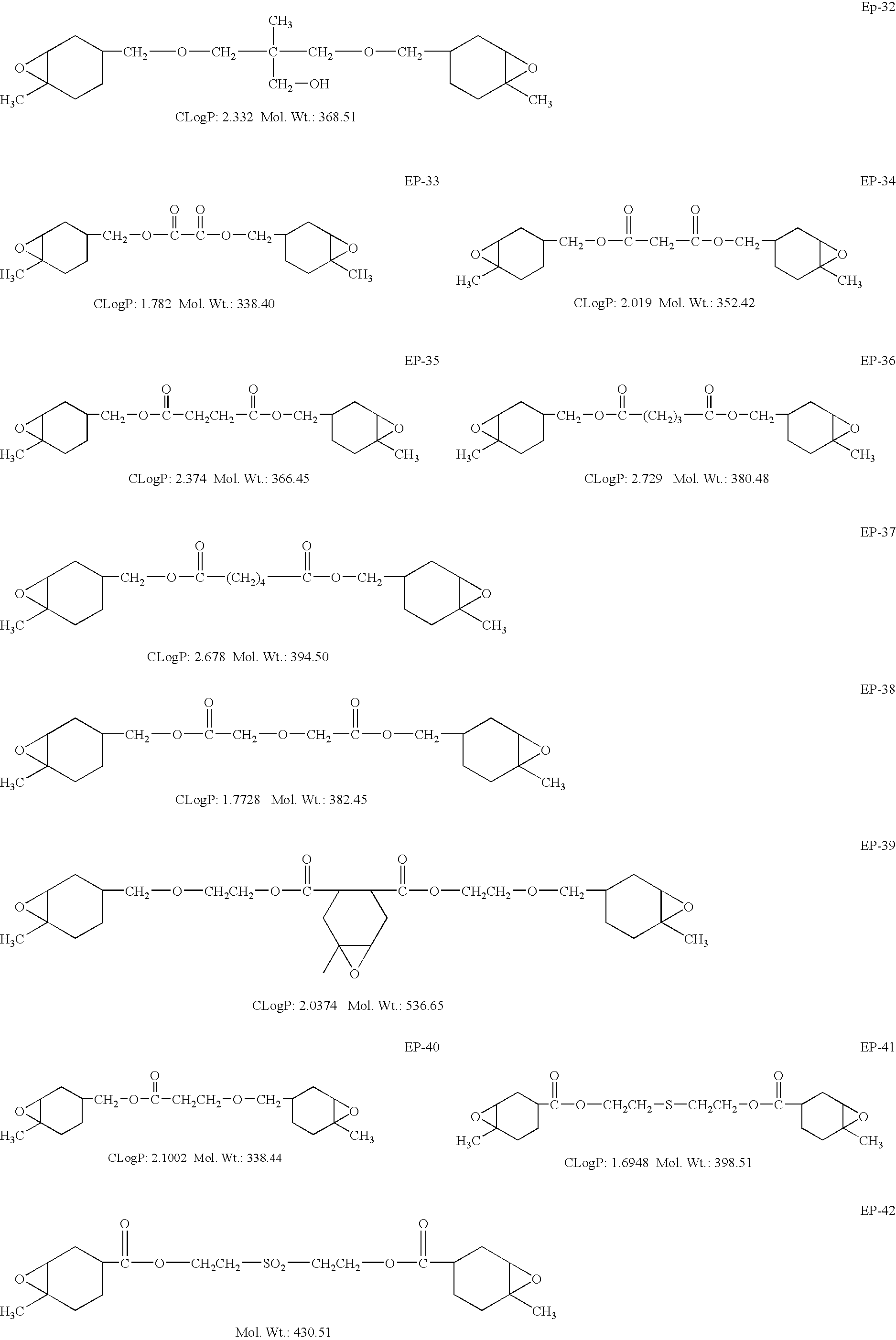

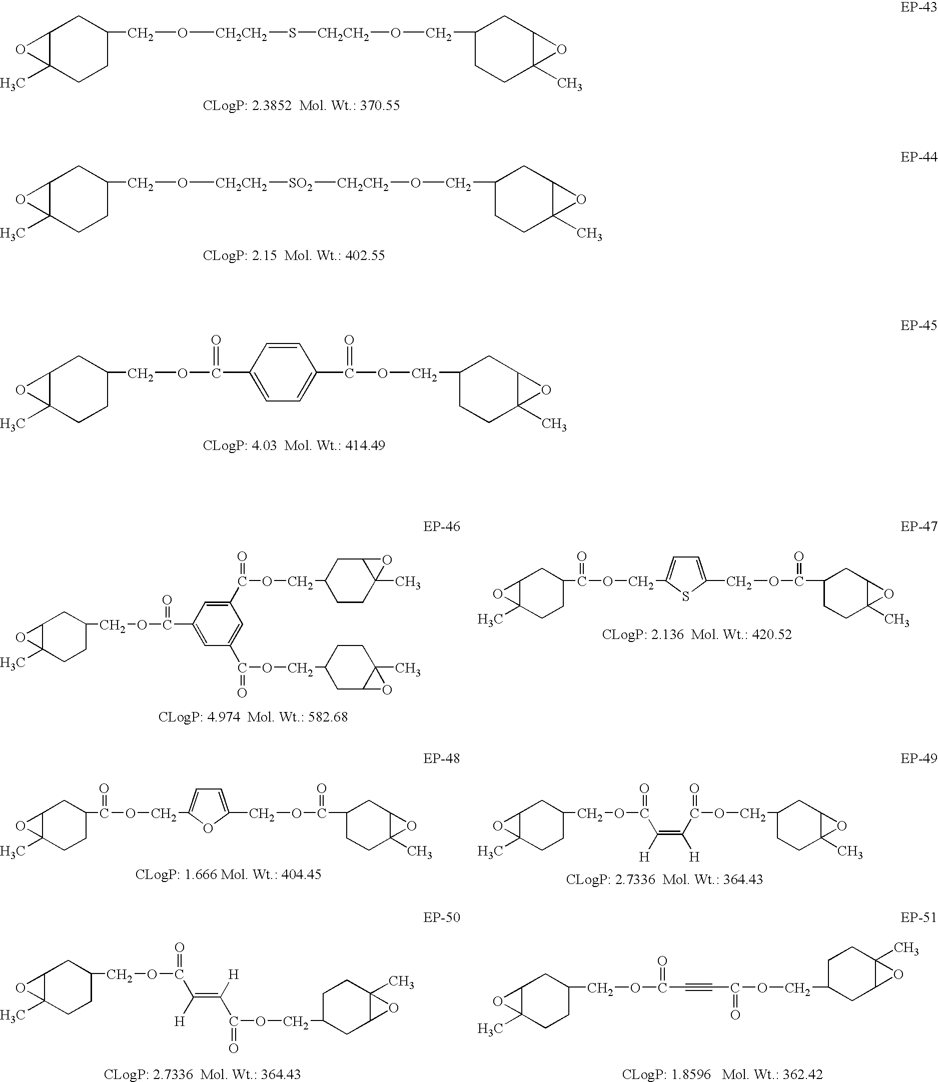

The synthesis of the epoxy compound of the invention can be performed according to the methods described in U.S. Pat. Nos. 2,745,847, 2,750,395, 2,853,498, 2,853,499 and 2,863,881.

Synthetic examples of the example compounds (EP-9, 12, 17, 31 and 35) are shown in the following (1) to (5), but the invention is not limited thereto.

### (1) SYNTHETIC EXAMPLE 1

### Synthesis of the example compound, EP-9: ethyleneglycol-bis-(4-methyl-3,4-epoxy-cyclohexanecarboxylate

### Synthesis of methyl-(4-methyl-3-cyclohexenecarboxylate

Methyl-(4-methyl-3-cyclohexenecarboxylate was synthesized using isoprene and methyl acrylate as basic ingredients by Diels-Alder reaction known in the art. The reaction was carried out by a reaction condition according to the condition described in the literatures (J. Organomet. Chem., 285:333-342, 1985; J. Phys. Chem., 95, 5:2293-2297, 1992; Acta. Chem. Scand., 47, 6:581-591, 1993) or U.S. Pat. No. 1,944,931, and the target compound was yielded at a high yield.

### Synthesis of ethyleneglycol-bis-(4-methyl-3-cyclohexenecarboxylete)

Toluene sulfonate monohydrate (1 g) was added to 340 g (2 mol) of methyl-(4-methyl-3-cyclohexenecarboxylate) and 62 g (1 mol) of ethyleneglycol, and reacted at 80 to 90° C. for 8 hours. A reaction solution was washed with an aqueous bicarbonate solution and subsequently distillation under reduced pressure was carried out to yield the target compound. The yield was 92%

Ethyleneglycol-bis-(4-methyl-3-cyclohexenecarboxylate) (306 g, 1 mol) was placed in a 2 L three neck flask, and 770 g of an acetone solution containing 25% by mass of peracetic acid (192 g of peracetic acid, 2.5 mol) was dripped over 4 hours as an inner temperature was retained at 35 to 40° C. After the completion of dripping, the reaction was continued at the same temperature for 4 hours. The reaction solution was stored at −11° C. overnight, and subsequently a remaining amount of peracetic acid was checked to confirm that 98% or more of a theoretical amount was reacted.

Then, the reaction solution was diluted with 1 L of toluene, and components with low boiling point were distilled off to eliminate by heating to 50° C. under reduced pressure by a water aspirator until no distillate was detected.

The remaining reaction composition was distilled under reduced pressure to yield the target compound. The yield was 78%. The structure of the product was confirmed by NMR and MASS analyses.

1H NMR (CDCl₃) δ(ppm): 1.31 (s, 6H, CH₃—), 1.45 to 2.50 (m, 14H, cyclohexane ring), 3.10 (m, 2H, epoxy root), 4.10 (s, 4H, —CH₂—O—)

### (2) SYNTHETIC EXAMPLE 2

### Synthesis of the example compound, EP-12: propane-1,2-diol-bis-(4-methyl-3,4-epoxy-cyclohexanecarboxylate)

### Synthesis of propane-1,2-diol-bis-(4-methyl-3-cyclohexenecarboxylate)

Toluene sulfonate monohydrate (1 g) was added to 340 g (2 mol) of methyl-(4-methyl-3-cyclohexenecarboxylate) and 76 g (1 mol) of propane-1,2-diol, and reacted at 80 to 90° C. for 8 hours. A reaction solution was washed with an aqueous bicarbonate solution, and subsequently distillation under reduced pressure was carried out to yield the target compound. The yield was 90%.

Propane-1,2-diol-bis-(4-methyl-3-cyclohexenecarboxylate) (320 g, 1 mol) was placed in a 2 L three neck flask, and 770 g of an acetone solution containing 25% by mass of peracetic acid (192 g of peracetic acid, 2.5 mol) was dripped over 4 hours as an inner temperature was retained at 35 to 40° C. After the completion of dripping, the reaction was continued at the same temperature for 4 hours. The reaction solution was stored at −11° C. overnight, and subsequently a remaining amount of peracetic acid was checked to confirm that 98% or more of a theoretical amount was reacted.

Then, the reaction solution was diluted with 1 L of toluene, and components with low boiling point were distilled off to eliminate by heating to 50° C. under reduced pressure by a water aspirator until no distillate was detected.

The remaining reaction composition was distilled under reduced pressure to yield the target compound. The yield was 75%. The structure of the product was confirmed by NMR and MASS analyses.

1H NMR (CDCl₃) δ(ppm): 1.23 (d, 3H, CH₃—), 1.31 (s, 6H, CH₃—), 1.31 (s, 6H, CH₃—), 1.45 to 2.50 (m, 14H, cyclohexane ring), 3.15 (m, 2H, epoxy root), 4.03 (m, 1H, —O—CH₂—), 4.18 (m, 1H, —O—CH₂—), 5.15 (m, 1H, >CH—O—)

### (3) SYNTHETIC EXAMPLE 3

### Synthesis of the example compound, EP-17: 2,2-dimethyl-propane-1,3-diol-bis-(4-methyl-3,4-epoxy-cyclohexanecarboxylate)

### Synthesis of 2,2-dimethyl-propane-1,3-diol-bis-(4-methyl-3-cyclohexenecarboxylate)

Toluene sulfonate monohydrate (1 g) was added to 340 g (2 mol) of methyl-(4-methyl-3-cyclohexenecarboxylate) and 104 g (1 mol) of propane-1,3-diol, and reacted at 80 to 90° C. for 12 hours. A reaction solution was washed with an aqueous bicarbonate solution, and subsequently distillation under reduced pressure was carried out to yield the target compound. The yield was 86%.

2,2-Dimethyl-propane-1,3-diol-bis-(4-methyl-3-cyclohexenecarboxylate) (348 g, 1 mol) was placed in a 2 L three neck flask, and 770 g of an acetone solution containing 25% by mass of peracetic acid (192 g of peracetic acid, 2.5 mol) was dripped over 4 hours as an inner temperature was retained at 40° C. After the completion of dripping, the reaction was continued at the same temperature for 4 hours. The reaction solution was stored at −11° C. overnight, and subsequently a remaining amount of peracetic acid was checked to confirm that 98% or more of a theoretical amount was reacted.

Then, the reaction solution was diluted with 1 L of toluene, and components with low boiling point were distilled off to eliminate by heating to 50° C. under reduced pressure by a water aspirator until no distillate was detected.

The remaining reaction composition was distilled under reduced pressure to yield the target compound. The yield was 70%. The structure of the product was confirmed by NMR and MASS analyses.

1H NMR (CDCl₃) δ(ppm): 0.96 (s, 6H, CH₃—), 1.31 (s, 6H, CH₃—), 1.45 to 2.50 (m, 14H, cyclohexane ring), 3.00 (m, 2H, epoxy root), 3.87 (s, 4H, —O—CH₂—).

### (4) SYNTHETIC EXAMPLE 4

### Synthesis of the example compound, EP-31: 1,3-bis-(4-methyl-3,4-epoxy-cyclohexylmethyloxy)-2-propanol

### Synthesis of 4-methyl-3-cyclohexylmethanol

By Diels-Alder reaction known in the art, 4-methyl-3-cyclohexenyl aldehyde was synthesized using isoprene and acrolein as basic ingredients. The reaction was carried out under a reaction condition according to the condition described in the literatures (J. Amer. Chem. Soc., 119(15): 3507-3512, 1997; Tetrahedron Lett., 40(32): 5817-5822, 1999) and the target compound was yielded at a high yield. Then, methyl-3-cyclohexenylmethanol was synthesized at a high yield by reducing this compound.

### Synthesis of 1,2-bis-(4-methyl-3-cyclohexenylmethyloxy)-2-propanol

Potassium carbonate (305 g, 2.2 mol) was added to 1 L solution of 284 g (2 mol) of 4-methyl-3-cyclohexenylmethanol and 92 g (1 mol) of epichlorohydrin in acetone, and reacted at 50° C. for 8 hours. Precipitated salt was eliminated by filtration, and a reaction solution was concentrated under reduced pressure. Subsequently, a remaining crude product was distilled under reduced pressure to yield the target compound. The yield was 90%.

1,2-Bis-(4-methyl-3-cyclohexenylmethyloxy)-2-ppropanol (308 g, 1 mol) was placed in a 2 L three neck flask, and 770 g of an acetone solution containing 25% by mass of peracetic acid (192 g of peracetic acid, 2.5 mol) was dripped over 4 hours as an inner temperature was retained at 35 to 40° C. After the completion of dripping, the reaction was continued at the same temperature for 4 hours. The reaction solution was stored at −11° C. overnight, and subsequently a remaining amount of peracetic acid was checked to confirm that 98% or more of a theoretical amount was reacted.

Then, the reaction solution was diluted with 1 L of toluene, and components with low boiling point were distilled off to eliminate by heating to 50° C. under reduced pressure by a water aspirator until no distillate was detected.

The remaining reaction composition was distilled under reduced pressure to yield the target compound. The yield was 83%. The structure of the product was confirmed by NMR and MASS analyses.

1H NMR (CDCl₃) δ(ppm): 1.31 (s, 6H, CH₃—), 1.4 to 2.0 (m, 14H, cyclohexane ring), 2.7 (s, 1H, —OH), 3.10 (m, 2H, epoxy root), 3.45 (d, 4H, —CH₂—O—), 3.50 (m, 4H, —CH₂—O—), 3.92(m, 1H, >CH—).

### (5) SYNTHETIC EXAMPLE 5

### Synthesis of the example compound, EP-35: bis-(4-methyl-3,4-epoxy-cyclohexylmethyl)oxalate

### Synthesis of bis-(4-methyl-3-cyclohexenylmethyl)succinate

Toluene sulfonate monohydrate (5 g) was added to 1 L solution of 284 g (2 mol) of 4-methyl-3-cyclohexenylmethanol and 100 g (1 mol) of succinic acid anhydride in toluene, and reacted at 110 to 120° C. for 8 hours as produced water was removed by a water separation apparatus. A reaction solution was washed with an aqueous bicarbonate solution, and toluene was distilled off by concentrating under reduced pressure. A remaining crude product was distilled under reduced pressure to yield the target compound. The yield was 90%.

Bis-(4-methyl-3-cyclohexenylmethyl)succinate (335 g, 1 mol) was placed in a 2 L three neck flask, and 770 g of an acetone solution containing 25% by mass of peracetic acid (192 g of peracetic acid, 2.5 mol) was dripped over 4 hours as an inner temperature was retained at 35 to 40° C. After the completion of dripping, the reaction was continued at the same temperature for 4 hours. The reaction solution was stored at −11° C. overnight, and subsequently a remaining amount of peracetic acid was checked to confirm that 98% or more of a theoretical amount was reacted.

Then, the reaction solution was diluted with 1 L of toluene, and components with low boiling point were distilled off to eliminate by heating to 50° C. under reduced pressure by a water aspirator until no distillate was detected.

The remaining reaction composition was distilled under reduced pressure to yield the target compound. The yield was 75%. The structure of the product was confirmed by NMR and MASS analyses.

1H NMR (CDCl₃) δ(ppm): 1.31 (s, 6H, CH₃—), 1.4 to 2.0 (m, 14H, cyclohexane ring), 3.10 (m, 2H, epoxy root), 2.62 (s, 4H, —CH₂—CO—), 4.05 (d, 4H, —CH₂—O—).

The other epoxy compounds used for the invention can be synthesized by similar methods at a good yield.

In the invention, the epoxy compound is combined at 10 to 70%, preferably from 20 to 50% by mass in the active energy ray curable composition.

(Oxetane Compound)

The oxetane compound used for the invention is the compound having one or more oxetane rings in the molecule. Specifically, it is possible to preferably use 3-ethyl-3-hydroxymethyloxetane (a brand name, OXT101 supplied from Toagosei Co., Ltd.), 1,4-bis [(3-ethyl-3-oxetanyl) methoxymethyl]benzene (OXT121 supplied from id.), 3-ethyl-3-(phenoxymethyl)oxetane (OXT211 supplied from id.), di (ethyl-3-oxetanyl)methylether (OXT221 supplied from id.), 3-ethyl-3-(2-ethylhexyloxymethyl) oxetane (OXT212 supplied from id.), and the like. Particularly, it is possible to preferably use 3-ethyl-3-hydroxymethyloxetane, 3-ethyl-3-(phenoxymethyl)oxetane and di(1-ethyl-3-oxetanyl)methyl ether. These can be used alone or in combination with two or more.

The oxetane compound is combined at 30 to 95%, preferably from 50 to 80% by mass in the active energy ray curable composition according to the invention.

In the active energy ray curable composition of the invention, it is possible to combine an oxirane group-containing compound in addition to the epoxy compound. This is the compound having one or more oxirane rings represented by the following structural formula in the molecule.

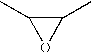

As the oxirane group-containing compound used for the invention, it is possible to use any of monomers, oligomers or polymers usually used as epoxy resins. Specifically included are aromatic epoxide, alicyclic epoxide and aliphatic epoxide conventionally known in the art. Hereinafter, the epoxide denotes a monomer or an oligomer thereof. One type or if necessary two or more types of these compounds may be used.

As the aromatic epoxide, preferred is di- or poly-glycidylether produced by the reaction of polyvalent phenol having at least one aromatic nucleus or alkylene oxide adduct thereof with epichlorohydrin. For example, included are di- or poly-glycidylether of bisphenol A or alkylene oxide adduct thereof, di- or poly-glycidylether of hydrogenated bisphenol A or alkylene oxide adduct thereof, and novolak type epoxy resins and the like. Here, alkylene oxide includes ethylene oxide, propylene oxide and the like.

As the alicyclic epoxide, preferred is a cyclohexene oxide-containing compound or a cyclopentene oxide-containing compound obtained by epoxidizing a compound having at least one cycloalkane ring such as cyclohexene ring or cyclopentene ring with an appropriate oxidizer such as hydrogen peroxide and peracid. Specifically, for example, it is possible to include Celloxide 2021, Celloxide 2021A, Celloxide 2021P, Celloxide 2080, Celloxide 2000, Epolead GT301, Epolead GT302, Epolead GT401, Epolead GT403, EHPE-3150, EHPEL3150CE supplied from Daicel Chemical Industries Ltd., UVR-6150, UVR-6110, UVR-6128, UVR-6100, UVR-6216 and UVR-6000 supplied from Union Carbide Corporation.

As preferable aliphatic epoxide, there are di- or poly-glycidylether of aliphatic polyvalent alcohol or alkylene oxide adduct thereof, and the like. As representative examples thereof, included are diglycidylether of alkylene glycol such as diglycidylether of ethyleneglycol, diglycidylether of propyleneglycol or diglycidylether of 6-hexanediol; diglycidylether of polyvalent alcohol such as di- or poly-glycidylether of glycerine or alkylene oxide adduct thereof; diglycidylether of polyalkylene glycol such as diglycidylether of polyethyleneglycol or alkylene oxide adduct thereof, diglycidylether of polypropyleneglycol or alkylene oxide adduct thereof, and the like. Here, alkylene oxide includes ethylene oxide, propylene oxide and the like.

Further, it is possible to use monoglycidylether of aliphatic higher alcohol and monoglycidylether of phenol and cresol in addition to these compounds. Considering rapid curability, in these epoxides, the aromatic epoxide and the alicyclic epoxide are preferable, and particularly the alicyclic epoxide is preferable.

These oxirane group-containing compound is combined at 0 to 50, preferably from 0 to 30% by mass in the active energy ray curable composition of the invention. Also, these oxirane group-containing compounds may be combined at 0 to 50% by mass and preferably from 0 to 30% by mass in a liquid component made up of the epoxy compound, the oxetane ring-containing compound, and the vinylether compound which is combined if necessary.

(Vinylether Compound)

As the vinylether compound comprised in the active energy ray curable composition of the invention, for example, included are divinyl or trivinyl ether compounds such as ethyleneglycol divinyl ether, ethyleneglycol monovinyl ether, diethyleneglycol divinyl ether, triethyleneglycol monovinyl ether, triethyleneglycol divinyl ether, propyleneglycol divinyl ether, dipropyleneglycol divinyl ether, butanediol divinyl ether, hexanediol divinyl ether, cyclohexane dimethanol divinyl ether, hydroxyethyl monovinyl ether, hydroxynonyl monovinyl ether and trimethylolpropane trivinyl ether, and monovinyl ether compounds such as ethylvinylether, n-butylvinylether, iso-butylvinylether, octadecylvinylether, cyclohexylvinylether, hydroxybutylvinylether, 2-ethylhexylvinylether, cyclohexanedimethanol monovinyl ether, n-propylvinylether, isopropylvinylether, isopropenyl ether-o-propylene carbonate, dodecylvinylether, diethyleneglycol monovinyl ether and octadecylvinylether, and the like.

Considering curability, adhesiveness and surface hardness, in these vinylether compounds, divinyl or trivinyl ether compounds are preferable, and particularly the divinyl ether compounds are preferable. In the invention, one type alone of the above vinylether compounds may be used, but two or more types may be used in an appropriate combination.

The vinylether compound can realize reduction of viscosity required for the active energy ray curable composition by combining, and can also improve a curing rate. The vinylether compound is combined at 0 to 40% and preferably from 0 to 20% by mass in the liquid component made up of the oxirane group-containing compound and the oxetane ring-containing compound.

(Cationic Photopolymerization Initiator)

As the cationic photopolymerization initiator used for the invention, included are arylsulfonium salt derivatives (e.g., Cyracure UVI-6990, Cyracure UVI-6974 supplied from Union Carbide Corporation, Adekaoptomer SP-150, Adekaoptomer SP-152, Adekaoptomer SP-170, Adekaoptomer SP-172 supplied from Asahi Denka Co., Ltd.), allyliodonium salt derivatives (e.g., RP-2074 supplied from Rhodia Inc.), allene-ion complex derivatives (e.g., Irgacure 261 supplied from Ciba-Geigy Ltd.), diazonium salt derivatives, triazine type initiators and acid generators such as the other halides. It is preferred that the cationic photopolymerization initiator is contained at a ratio of 0.2 to 20 parts by mass based on 100 parts by mass of the compound having alicyclic epoxy group. When the content of cationic photopolymerization initiator is less than 0.2 parts by mass, it is difficult to yield a cured matter whereas even when it is contained at more than 20 parts by mass, there is no improved curable effect. These cationic photopolymerization initiator can be used by selecting one or two or more types.

In the invention, suitably used are sulfonium salts represented by the above general formulae (4) to (7), which do not produce benzene by irradiating the active energy ray. “Not produce benzene by irradiating the active energy ray” indicates that benzene is not substantially produced, and specifically indicates that an amount of produced benzene is an ultra trace amount of 5 μg or less or nil when an image with a thickness of 15 μm and about 100 m² is printed using an active energy ray curable compound containing 5% by mass of sulfonium salt (photo oxygen generator) in the active energy ray curable composition, and active energy ray at an amount where the photo oxygen generator is sufficiently decomposed is irradiated onto a film face of the active energy ray curable composition retained at 30° C. As the sulfonium salt, preferable are the sulfonium salt compounds represented by the general formulae (4) to (7) and those having substituent(s) on a benzene ring bound to S+satisfy the above condition.

In the general formulae (4) to (7), R₁ to R₁₇ each represent hydrogen atoms or substituents, R₁ to R₃ do not represent hydrogen atoms simultaneously, R₄ to R₇ do not represent hydrogen atoms simultaneously, R₈ to R₁₁ do not represent hydrogen atoms simultaneously, and R₁₂ to R₁₇ do not represent hydrogen atoms simultaneously.

Substituents represented by R₁ to R₁₇ can preferably include alkyl groups such as methyl, ethyl, propyl, isopropyl, butyl, isobutyl, t-butyl, pentyl and hexyl groups, alkoxy groups such as methoxy, ethoxy, propoxy, butoxy, hexyloxy, decyloxy and dodecyloxy groups, carbonyl groups such as acetoxy, pronionyloxy, decylcarbonyloxy, dodecylcarbonyloxy, methoxycarbonyl, ethoxycarbonyl and benzoyloxy groups, phenylthio groups, halogen atoms such as fluorine, chlorine, bromine and iodine, cyano, nitro, hydroxy groups and the like.

X represents a non-nucleophilic anion residue, and for example can include halogen atoms such as F, Cl, Br and I, B (C₆F₅)₄, R₁₈COO, R₁₉SO₃, SbF₆, AsF₆, PF₆, BF₄, and the like. But R₁₈ and R₁₉ represent alkyl or phenyl group which may be substituted with alkyl groups such as methyl, ethyl, propyl and butyl groups, halogen atoms such as fluorine, chlorine, bromine and iodine, nitro group, cyano group, alkoxy groups such as methoxy and ethoxy groups, and the like. In these, B(C₆F₅)₄ and PF₆ are preferable in terms of safety.

As with the photo oxygen generators described in The Chemical Society of Japan, Vol. 71 No. 11, 1998 (edited by The Japanese Research Association for Organic Electronics Materials) and “Imejingu yo Yuki Zairyo (Organic Materials for Imaging)” published by Bun-Shin Publication, 1993, the above compounds can be easily synthesized by the methods known in the art.

In the invention it is particularly preferred that the sulfonium salt represented by the general formulae (4) to (7) is at least one of the sulfonium salts selected from the above general formulae (8) to (16). X represents a non-nucleophilic anion residue and is the same as the above.

As a photopolymerization accelerator, included are anthracene and anthracene derivatives (e.g., Adekaoptomer SP-100 supplied from Asahi Denka Co., Ltd.). These photopolymerization accelerators can be used alone or in combination with multiple types.

(Pigments)

As pigments comprised in the active energy ray curable composition of the invention (in particular, the pigments comprised in an inkjet ink when the active energy ray curable composition according to the invention is used as the inkjet ink), it is possible to use achromatic color inorganic pigments such as carbon black, titanium oxide and calcium carbonate or chromatic color organic pigments. As the organic pigments, included are insoluble azo pigments such as toluidine red, toluidine maroon, Hansa yellow, benzidine yellow and pyrazolone red, soluble pigments such as litol red, helio bordeaux, pigment scarlet and permanent red 2B, derivatives from building dyes such as alizarin, indan-throne and thioindigo maroon, phthalocyanine type organic pigments such as phthalocyanine blue and phthalocyanine green, quinacridone type organic pigments such as quinacridone red and quinacridone magenta, pelylene type organic pigments such as pelylene red and pelylene scarlet, isoindolinone type organic pigments such as isoindolinone yellow and isoindolinone orange, pyranthrone type organic pigments such as pyranthrone red and pyranthrone orange, thioindigo type organic pigments, condensed azo type organic pigments, benzimidazolone type organic pigments, quinophthalone type organic pigments such as quinophthalone yellow, isoindoline type organic pigments such as isoindoline yellow, and as the other pigments, flavanthrone yellow, acylamide yellow, nickel azo yellow, copper azo yellow, perinone orange, anthrone orange, dianthraquinonyl red, dioxadine violet and the like.

When the organic pigments are exemplified by Color Index (C.I.) number, included are C.I. pigment yellow 12, 13, 14, 17, 20, 24, 74, 83, 86, 93, 109, 110, 117, 125, 128, 129, 137, 138, 139, 147, 148, 150, 151, 153, 154, 155, 166, 168, 180, 185, C.I. pigment orange 16, 36, 43, 51, 55, 59, 61, C.I. pigment red 9, 48, 49, 52, 53, 57, 97, 122, 123, 149, 168, 177, 180, 192, 202, 206, 215, 216, 217, 220, 223, 224, 226, 227, 228, 238, 240, C.I. pigment violet 19, 23, 29, 30, 37, 40, 50, C.I. pigment blue 15, 15:1, 15:3, 15:4, 15:6, 22, 60, 64, C.I. pigment green 7, 36, C.I. pigment brown 23, 25, 26, and the like.

In the above pigments, preferable are the quinacridone type organic pigments, phthalocyanine type organic pigments, benzimidazolone type organic pigments, isoindolinone type organic pigments, condensed azo type organic pigments, quinophthalone type organic pigments and isoindoline type organic pigments because they are excellent in photo resistance. It is preferred that the organic pigments are fine pigments with an average particle diameter of 10 to 150 nm in measurement by laser diffusion. When the average particle diameter is less than 10 nm, reduction of photo resistance occurs due to reduced particle diameters, whereas when it is more than 150 nm, stable maintenance of the dispersion becomes difficult easily resulting in precipitation of the pigments.

Downsizing the organic pigments can be carried out by the following method. That is, a mixture made up of at least three components, the organic pigments, a water soluble inorganic salt at an amount of three times or more by mass of the organic pigments and a water soluble solvent is made into the clayey mixture, strongly kneaded by a kneader to downsize followed by putting into water, and stirred by a high speed mixer to make into slurry. Then, filtration and washing of the slurry are repeated to eliminate the water soluble inorganic salt and the water soluble solvent. Resin, a pigment dispersant and the like may be added at a step of downsizing. The water soluble inorganic salts include sodium chloride, potassium chloride and the like. These inorganic salts are used in the range of three times or more, and preferably 20 times or less by mass of the organic pigments. When an amount of the inorganic salt is less than three times by mass, the treated pigments with desired size are not obtained. Also when it is more than 20 times by mass, washing treatment at the following step is increased and the substantial amount of the treated organic pigments is reduced.

The water soluble solvent is used to make a moderate clayey condition of the organic pigments and the water soluble inorganic salt used as a pulverizing aid and efficiently perform sufficient pulverization, and is not particularly limited as long as it is the solvent which dissolves in water, but the solvents with high boiling point of 120 to 250° C. are preferable in terms of safety because the solvent easily evaporates due to an elevated temperature at the kneading. The water soluble solvents include 2-(methoxymethoxy)ethanol, 2-butoxyethanol, 2-(isopentyloxy)ethanol, 2-(hexyloxy)ethanol, diethyleneglycol, diethyleneglycol monomethylether, diethyleneglycol monoethylether, diethyleneglycol monobutylether, triethyleneglycol, triethyleneglycol monomethylether, liquid polyethyleneglycol, 1-methoxy-2-propanol, 1-ethoxy-2-propanol, dipropyleneglycol, dipropyleneglycol monomethylether, dipropyleneglycol monoethylether, low molecular weight polypropyleneglycol and the like.

Besides, as the pigments comprised in the active energy ray curable composition of the invention, it is possible to use various matters such as organic pigments and/or inorganic pigments. Specifically, included are white pigments such as titanium oxide, zinc flower, white lead, lithopone and antimony oxide, black pigments such as aniline black, black synthetic oxide and carbon black, yellow pigments such as yellow lead, yellow ferric oxide, hansa yellow (100, 50, 30, etc.), titanium yellow, benzine yellow and permanent yellow. orange pigments such as chrome vermillion, permanent orange, Vulcan first orange and Indanthrene Brilliant orange, brown pigments such as ferric oxide, permanent brown and parabrown, red pigments such as colcothar, cadmium red, antimony cinnabar, permanent red, rhodamine lake, alizarin lake, thioindigo red, PV carmine, monolight first red and quinacridone type red pigments, violet pigments such as cobalt violet, manganese violet, first violet, methyl violet lake, Indanthrene Brilliant violet, and dioxadine violet, blue pigments such as ultramarine blue, Prussian blue, cobalt blue, alkali blue lake, no metal phthalocyanine blue, copper phthalocyanine blue, Indanthrene blue and indigo, green pigments such as chrome green, chromium oxide, emerald green, naphthol green, green gold, acid green lake, malachite green, phthalocyanine green and polychlorobromocopper phthalocyanine, and additionally various fluorescent pigments, metal powder pigments, extender pigments, and the like.

In the invention, to obtain a sufficient concentration and sufficient photo resistance, it is preferred that the pigments are comprised at the range of 3 to 50% by mass in the active energy ray curable composition. When the active energy ray curable composition is used as an inkjet ink, it is preferred that the pigments comprised in the inkjet ink is comprised at the range of 3 to 15% by mass in the ink in order to obtain a sufficient concentration and sufficient photo resistance.

The following materials in addition to the above components can be added to the active energy ray curable composition of the invention at the amount up to 50% by mass in the active energy ray curable composition depending on the intended use.

When the intended uses are printing inks, coating paints and adhesives for cans, plastics, paper, woods and the like, it is possible to combine inert components such as an inorganic filler, softener, anti-oxidant, anti-aging, stabilizer, adhesiveness imparting resin, leveling agent, defoaming agent, plasticizer, dye, treating agent, viscosity controlling agent, organic solvent, lubricity imparting agent and ultraviolet blocking agent. Examples of the inorganic fillers include, for example, metal/non-metal oxides such as zinc oxide, aluminium oxide, antimony oxide, calcium oxide, chromium oxide, tin oxide, titanium oxide, ferric oxide, copper oxide, lead oxide, bismuth oxide, magnesium oxide and manganese oxide, hydroxides such as aluminium hydroxide, ferrous hydroxide and calcium hydroxide, salts such as calcium carbonate and calcium sulfate, silicon compounds such as silica dioxide, natural pigments such as kaolin, bentonite, clay and talc, minerals such as natural zeolite, Oyaishi stone, natural mica and ionite, synthetic inorganic matters such as artificial mica and synthetic zeolite, and various metals such as aluminium, iron and zinc, and the like. In these, there are those which duplicate in the above pigments, but these can be also combined as fillers in the composition in addition to the pigments of essential component. The lubricity imparting agent is combined for the purpose of improving the lubricity of obtained film, and for example, can include waxes such as fatty acid ester wax which is esterified one of a polyol compound and fatty acid, silicon type wax, fluorine type wax, polyolefin wax, animal type wax and plant type wax. The adhesiveness imparting resins include, for example, rosins such as rosin acid, polymerized rosin acid and rosin acid ester, terpene resin, terpene phenol resin, aromatic hydrocarbon resin, aliphatic saturated hydrocarbon resin and petroleum resin, and the like.

When phototyping three dimensional modelling is the intended use, thermoplastic high molecular compounds can be further added. The thermoplastic high molecular compound is the high molecular compound which is liquid or solid at room temperature and is evenly blended with a resin composition at room temperature. Representatives of such thermoplastic high molecular compounds include polyester, polyvinyl acetate, polyvinyl chloride, polybutadiene, polycarbonate, polystyrene, polyvinylether, polyvinyl butyral, polyacrylate, polymethylmethacylate, polybutene, hydrogenated styrene butadiene block copolymer, and the like. Also, it is possible to use those where functional groups such as hydroxyl, carboxyl, vinyl and epoxy groups are introduced to these thermoplastic high molecular compounds. With respect to such thermoplastic high molecular compounds, a number average molecular weight desirable for the invention is from 1000 to 500000, and more preferably from 5000 to 100000 in the invention. The compound with a molecular weight which is out of this range can not be necessarily used, but when the molecular weight is excessively low, the effect for improving strength is not sufficiently obtained whereas when it is excessively high, viscosity of the resin composition becomes high and the composition becomes unfavorable as the resin composition for the phototyping three dimensional modelling.

For concoction of the active energy ray curable composition, mixing methods are not limited as long as these materials can be thoroughly mixed. Specific mixing methods include an agitation method which utilizes an agitation force involved in rotation of propeller, a roll kneading method, common dispersing machines such as a sand mill, and the like.

As the active energy ray which cures the active energy ray curable composition of the invention, there are ultraviolet ray, electron ray, X-ray, radiation ray, high frequency wave and the like, and the ultraviolet ray is economically the most preferable. As light sources of the ultraviolet ray, there are ultraviolet laser, mercury lamp, xenon lamp, sodium lamp, alkali metal lamp, and the like, and the laser light is particularly preferable when light condensing is required.

Outlines of use methods depending on the intended uses will be described below.

When the intended use is printing ink, the active energy ray curable composition of the invention can be used in various printing methods, for example, surface printing such as offset printing, relief printing, silk screen printing or gravure printing, or the like using paper, film or sheet as a substrate. The composition is cured by irradiating the active energy ray after printing. The active energy ray includes ultraviolet ray, X-ray and electron ray, and the like. As light sources which can be used when cured by the ultraviolet ray, various sources can be used and, for example included are pressurized or high pressure mercury lamp, metal halide lamp, xenon lamp, electrodeless discharge lamp or carbon arc lamp or the like. When cured by the electron ray, various irradiating apparatuses can be used, and for example, include Cockcraft-Walton type, Van de Graaff type, or resonate potential transformer type, or the like. The electron ray preferably has energy of 50 to 1000 eV, and more preferably from 100 to 300 eV. In the present invention, it is preferable to use the ultraviolet ray for curing the composition because an inexpensive apparatus can be used.

When the intended use is coating paint for cans, plastics, paper, woods and the like, the active energy ray curable composition of the invention can be applied for coating of various metallic materials, plastic materials, paper, woods and the like. The metallic materials include, for example, electric positive plated steel sheets, tin free steel, aluminium and the like. The plastic materials can include, for example, polycarbonate, polymethylmethacrylate, polyethylene terephthalate, vinyl chloride resins and ABS resins, as well as plain paper of which major component is cellulose, and the paper of which surface is treated with polyethylene, polyvinyl chloride, polypropylene, polyester, polycarbonate or polyimide, or the like. Also it is possible to include natural woods including Japanese cherry, red oak, rosewood, Chinese quince (karin), mahogany, lauan, mulberry tree, box tree, kaya, amur cork, Japanese white-bark magnolia, Japanese Judas tree, zelkova, walnut tree, Japanese cinnamon, oak, teak, Japanese persimmon, lignitized Japanese Judas tree, lignitized Japanese cedar, black persimmon, ebony wood, Macassar ebony, buckeye, maple tree, basket willow and ash plant, and the like, modified woods such as plywood, laminated wood, particle board and printed plywood, as well as flooring materials, furnitures and wall materials manufactured from these natural and modified woods. These may be plate or film shape. A film thickness of the active energy ray curable composition of the invention on the substrate surface can be appropriately selected depending on the intended use. The film thickness is preferably from 1 to 50 μm, and more preferably from 3 to 20 μm. A use method of the active energy ray curable composition of the invention is not especially limited, and may be carried out according to the methods conventionally known. For example, there is the method where the active energy ray curable composition of the invention is applied by the method such as dipping, flow coating, spraying, bar coating, gravure coating, roll coating, blade coating or air knife coating using a coating machine, and subsequently cured by irradiating the active energy ray. The active energy ray includes ultraviolet ray, X-ray and electron ray, and the like. As the light sources which can be used when cured by the ultraviolet ray, various types can be used, for example, included are pressurized or high pressure mercury lamp, metal halide lamp, xenon lamp, electrodeless discharge lamp or carbon arc lamp or the like. When cured by the electron ray, various irradiating apparatuses can be used, and for example, include Cockcraft-Walton type, Van de Graaff type, or resonate potential transformer type, or the like. The electron ray preferably has energy of 50 to 1000 eV, and more preferably from 100 to 300 eV. In the invention, it is preferable to use the ultraviolet ray for curing the composition because an inexpensive apparatus can be used. After coating the active energy ray curable composition of the invention on the plastic material, if necessary, it is also possible to perform working such as molding, printing or transfer. When molding is performed, included are the method where a substrate having the active energy ray curable composition coating film of the invention is heated at an appropriate temperature and subsequently the molding is performed using the method such as vacuum molding, vacuum pneumatic molding, pneumatic molding or mat molding, and the method where only a coating film layer is molded as a case where emboss is molded on the active energy ray curable composition coating film of the invention, as replication of concavoconvex shapes such as interference patterns on CD and records. When printing is performed, the printing is performed on the coating film by an ordinary method using an ordinary printer. When transfer is performed, for example, the active energy ray curable composition coating film of the invention is applied on a substrate such as polyethylene terephthalate film, if needed the above printing and molding are performed to apply an adhesive layer followed by transferring to the other substrate.

When the intended use is the adhesive, a use method of the active energy ray curable composition of the invention is not especially limited, and it could be used according to the method usually used in laminate manufacture. For example, included is the method where the active energy ray curable composition of the invention is coated on a first thin layer adherent, dried if necessary, subsequently a second thin layer adherent is attached thereto, and the active energy ray is irradiated. Here, at least one of the thin layer adherents is required to be plastic film. The thin layer adherents include plastic film, paper or metallic foil, or the like. Here, the plastic film is referred to those which can transmit the active energy ray. A film thickness could be selected depending on the thin layer adherent used and the intended use, but is preferably 0.2 mm or less. The plastic films include, for example, polyvinyl chloride resins and polyvinylidene chloride, cellulose type resins, polyethylene, polypropylene, polystyrene, ABS resins, polyamide, polyester, polyurethane, polyvinyl alcohol, ethylene-vinyl acetate copolymer and chlorinated polypropylene, and the like. The paper can include simili paper, quality paper, kraft paper, art coated paper, caster coated paper, virgin white machine glazed paper, parchment paper, water resistant paper, glassine paper and corrugated card board, and the like. The metallic foil can include, for example aluminium foil and the like. Coating to the thin layer adherent could be performed according to the method conventionally used, which includes natural coater, knife belt coater, floating coater, knife over roll, knife on blanket, spray, dip, kiss roll, squeeze roll, reverse roll, air blade, curtain flow coater and gravure coater, and the like. An application thickness of the active energy ray curable composition of the invention may be selected depending on the thin layer adherent used and the intended use, but is preferably from 0.1 to 1000 μm, and more preferably from 1 to 50 μm. The active energy ray includes ultraviolet ray, X-ray and electron ray, and the like. As light sources which can be used when cured by the ultraviolet ray, various types can be used, and for example, included are pressurized or high pressure mercury lamp, metal halide lamp, xenon lamp, electrodeless discharge lamp or carbon arc lamp or the like. When cured by the electron ray, various irradiating apparatuses can be used, and for example, include Cockcraft-Walton type, Van de Graaff type, or resonate potential transformer type, or the like. The electron ray preferably has energy of 50 to 1000 eV, and more preferably from 100 to 300 eV. In the present invention, it is preferable to use the ultraviolet ray for curing the composition because an inexpensive apparatus can be used.

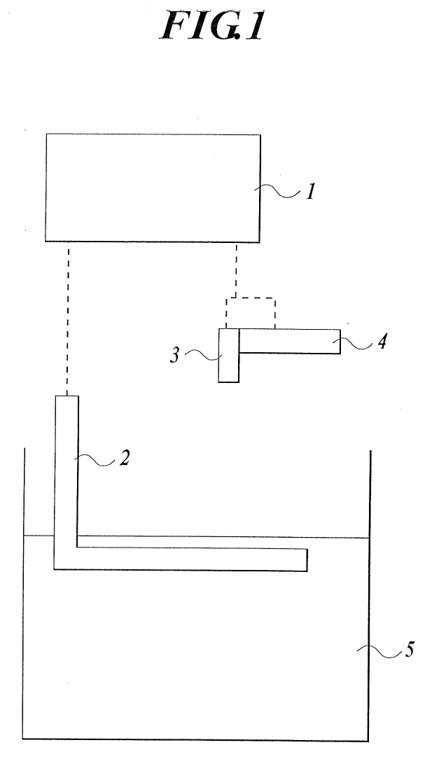

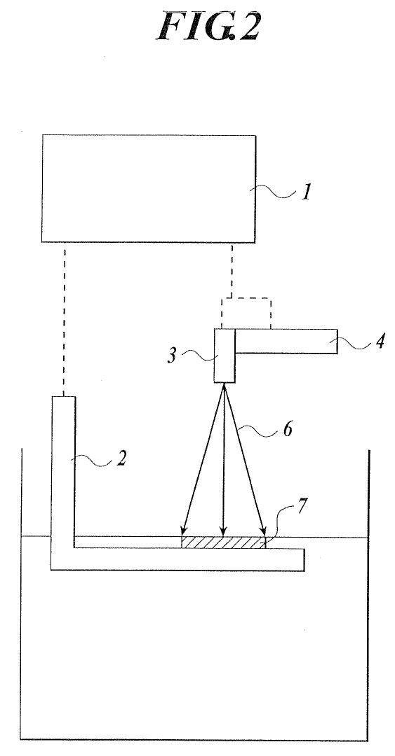

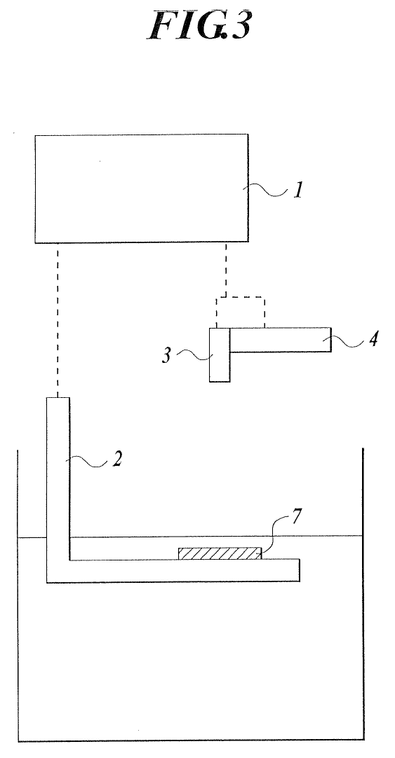

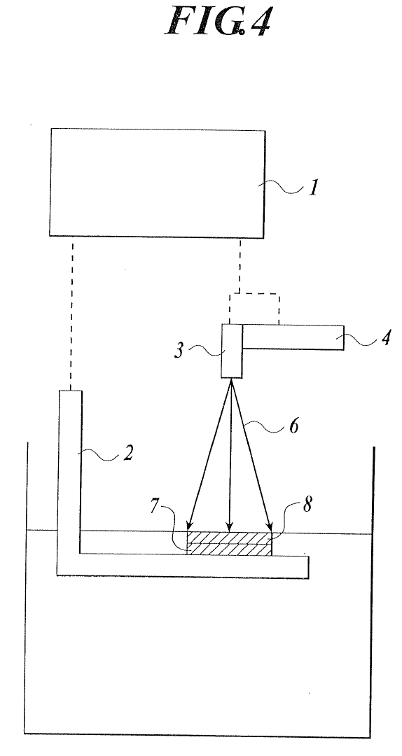

When the intended use is phototyping three dimensional modelling, lamination manipulation is performed where the energy ray is irradiated on a given surface of the active energy ray curable composition of the invention to form a cured layer with the desired thickness, the above active energy ray curable composition is further supplied on the cured layer, and this is similarly cured to obtain a cured layer continuing the above cured layer, and a three dimensional matter is obtained by repeating this manipulation. Further specifically illustrating in reference to figures, as is shown in FIG. 1, NC table 2 is located in the composition 5, and an uncured composition layer at a depth corresponding to the desired pitch is formed on the table 2. Next, according to a signal from a control section 1 on the basis of CAD data, laser light 6 from laser 4 is scanned and irradiated on the surface of uncured composition by controlling an optical system 3 to obtain a first cured layer 7 (see FIG. 2). Next, according to the signal from the control section 1, NC table is taken down, and an uncured composition layer at a depth corresponding to the desired pitch is further formed on the first cured layer 7 (see FIG. 3). A second cured layer 8 is obtained by similarly scanning and irradiating the laser light 6 (see FIG. 4). Lamination is further carried out in similar fashion.

(Pigment Dispersant)

As the pigment dispersant used for the invention, it is possible to include hydroxyl group-containing carboxylic acid ester, salts of long chain polyaminoamide and high molecular weight acid ester, salts of high molecular weight polycarboxylic acid, salts of long chain polyaminoamide and polar acid ester, high molecular weight unsaturated acid ester, high molecular copolymers, modified polyurethane, modified polyacrylate, polyetherester type anionic activators, condensed salts of naphthalene sulfonate formalin, condensed salts of aromatic sulfonate formalin, polyoxyethylenealkyl phosphoric acid esters, polyoxyethylenenonylphenyl ethers, stearylamine acetate, pigment derivatives and the like.

Specific examples of the pigment dispersants include “Anti-Terra-U (polyaminoamide phosphate)”, “Anti-Terra-203/204 (high molecular weight carboxylate salt)”, “Disperbyk-101 (polyaminoamide phosphate and acid ester), 107 (hydroxyl group-containing carboxylic acid ester), 110 (copolymer including an acid group), 130 (polyamide), 161, 162, 163, 164, 165, 166, 170 (high molecular copolymers)”, “400”, “Bykumen” (high molecular weight unsaturated ester), “BYK-P104, P-105 (high molecular weight unsaturated acid carboxylic acid)”, “P104S, 240S (high molecular weight unsaturated polycarboxylic acid and silicon system)” and “Lactimon (long chain amine and unsaturated acid polycarboxylic acid and silicon), supplied from BYK Chemie GmbH.

Also included are “Efka 44, 46, 47, 48, 49, 54, 63, 64, 65, 66, 71, 701, 764, 766”, “Efka polymer-100 (modified polyacrylate), 150 (aliphatic type modified polymer), 400, 401, 402, 403, 450, 451, 452, 453 (modified polyacrylate), 745 (copper phthalocyanine type)” supplied from Efka Chemicals B.V., “Flowlen TG-710 (urethane oligomer)”, “Flownon SH-290, SP-1000”, “Polyflow No. 50E, No. 300 (acryl type copolymers)” supplied from Kyoeisha Chemical Co., Ltd., “Disparon KS-860, 873SN, 874 (high molecular dispersants), #2150 (aliphatic polyvalent carboxylic acid), #7004 (polyetherester type)” supplied from Kusumoto Chemicals Ltd.

Additionally, included are “Demol RN, N (sodium salt of naphthalene sulfonate formalin condensed matter), MS, C, SN-B (sodium salt of aromatic sulfonate formalin condensed matter), EP”, “Homogenol L-18 (polycarboxylic acid type polymer)”, “Emulgen 920, 930, 931, 935, 950, 985 (polyoxyethylene nonylphenylether)”, “acetamin 24 (coconut amine acetate), 86 (stearylamine acetate)” supplied from Kao Corporation, “Solsperse 5000 (phthalocyanine ammonium salt type), 13240, 13940 (polyesteramine type), 17000 (fatty acid amine type), 24000, 32000” supplied from Zeneca Corporation, “Nikkol T106 (polyoxyethylene sorbitan monooleate), MYS-IEX (polyoxyethylene monostearate) Hexagline 4-0 (hexaglyceryltetraoleate)” supplied from Nikko Chemicals Ltd., and the like.

It is preferred that the pigment dispersant is contained at the range of 0.1 to 10% by mass in the active energy ray curable composition according to the invention.

The active energy ray curable composition of the invention is produced by thoroughly dispersing the pigment dispersant and the pigments along with the other composition using a usual dispersing machine such as a sand mill. It is preferred that a concentrated solution of the pigments at a high concentration is precedently made and then is diluted with the composition other than the concentrated solution of pigments. In this method, sufficient dispersion is possible in the dispersion by a usual dispersing machine, and thus, excessive dispersion energy is not needed and a lot of dispersion time is not required. Therefore, deterioration change in quality is difficult to occur at the dispersion of the active energy ray curable composition components, and the active energy ray curable composition excellent in stability is prepared. It is preferable to filtrate the active energy ray curable composition through a filter with a pore diameter of 3 μm or less and further 1 μm or less.

For the active energy ray curable composition of the invention, it is preferable to adjust the viscosity at 25° C. to a little too high value of 5 to 50 mPa·s. The active energy ray curable composition with viscosity at 25° C. of 5 to 50 mPa·s exhibits stable jetting property particularly at the head having standard frequency of 4 to 10 kHz and even at the head having high frequency of 10 to 50 kHz. When the viscosity is less than 5 mPa·s, reduction of jetting following property is observed at the head with high frequency. When it is more than 50 mPa·s, the jetting itself is reduced even if a lowering mechanism of the viscosity by heating is incorporated into the head, and stability of the jetting becomes poor or the jetting becomes impossible.

For the active energy ray curable composition of the invention, it is preferred that an electric conductivity is 10 μS/cm or less at the piezo head and the composition is made into the composition with no electric corrosion inside the head. Also, in a continuous type, the adjustment of electric conductivity by electrolytes is necessary, and in this case, it is required to adjust the electric conductivity to 0.5 mS/cm or more.

(Substrate)

The substrates used in the invention aim at all of wide-scale synthetic resins conventionally used for various intended uses. Specifically, included are, for example, polyester, polyvinyl chloride, polyethylene, polyurethane, polypropylene, acrylic resins, polycarbonate, polystyrene, acrylonitrile-butadiene-styrene copolymer, polyethylene terephthalate, polybutadiene terephthalate and the like. The thickness and shapes of these synthetic resin substrates are not limited at all.

When the active energy ray curable composition of the invention is used (particularly when the active energy ray curable composition is used as an inkjet ink), first, this active energy ray curable composition is supplied to the printer head of the printer for inkjet recording mode, jetted onto the substrate from this printer head, and subsequently, the active energy ray such as ultraviolet ray or electron ray is irradiated. This rapidly cures the active energy ray curable composition on a printing medium.

When the ultraviolet ray is irradiated as the active energy ray, it is possible to use, for example, a mercury arc lamp, a xenon arc lamp, a fluorescence lamp, a carbon arc lamp, a tungsten-halogen copy lamp and sun light. When cured by the electron ray, the cure is typically performed by the electron ray with energy of 300 eV or less, but it is also possible to cure in no time with a dose of 1 to 5 Mrad.

### EXAMPLES

The present invention is described below by Examples 1 and 2, but the embodiments of the invention are not limited thereto.

In Example 1, shown is a case where the active energy ray curable composition according to the invention was applied to an inkjet ink.

### Example 1

[Manufacture of Inks 1 to 7]

The pigments, the dispersant, the epoxy compound, the oxetane ring-containing compound and the vinylether compound shown in Table 1 were placed in a sand mill and dispersed for 4 hours to yield an ink stock. Then, the cationic photopolymerization initiator shown in Table 1 was added to the ink stock, and gently mixed until the cationic photopolymerization initiator was dissolved. Subsequently, this was filtrated through a membrane filter by applying pressure to yield the inks 1 to 7 of the invention.

Respective compounds in the table are shown below. Numerals represent parts by mass.

(Pigments)

P1: crude copper phthalocyanine (“Copper Phthalocyanine” supplied from Toyo Ink Mfg. Co., Ltd.) (250 parts), 2500 parts of sodium chloride and 160 parts of polyethyleneglycol (“Polyethyleneglycol 300” supplied from Tokyo Kasei Kogyo Cp., Ltd.) were placed in a styrene 1 gallon kneader (supplied from Inoue Manufacturing Co., Ltd.), and kneaded for 3 hours. Next, this mixture was put in 2.5 L of warm water, and stirred by a high speed mixer for about one hour with heating at about 80° C. to make slurry. Subsequently, filtration and washing with water were repeated 5 times to eliminate sodium chloride and the solvent, and then drying was performed by spray-drying to yield the treated pigments.

(Oxetane Compound)

OXT 221: Oxetane ring-containing compound (supplied from Toagosei Co., Ltd.)

(Oxirane Compound)

CEL 2000: 3-Vinyl-7-oxa-bicyclo[4.1.0]heptane (supplied from Daicel Chemical Industries, Ltd.)

(Vinylether Compound)

DVE-3: Triethyleneglycol divinyl ether (supplied from ISP).

(Pigment Dispersant)

Solsperse 32000: Aliphatic modification type dispersant (supplied from Zeneca Corporation)

(Cationic Photopolymerization Initiator)

Adekaoptomer SP-152: Triphenyl sulfonate salt (supplied from Asahi Denka Co., Ltd.)

[Manufacture of Ink 8]

The ink 8 for comparison was made as is the case with the manufacture of the ink 1, except using Celloxide 2121P (alicyclic epoxy supplied from Daicel Chemical Industries, Ltd.) in place of the example compound.

TABLE 1

| | | Epoxy | | | | | Amount of | | |
|---|---|---|---|---|---|---|---|---|---|
| Ink | Amount of | Compound | | Amount of | Amount of | Amount of | Solsperse | Amount of | |
| No. | P1 | Type | Amount | OXT221 | CEL2000 | DVE-3 | 32000 | SP-152 | Note |
| 1 | 5 | Example | 30 | — | — | 10 | 3 | 152 | Invention |
| | | Compound 1 | | | | | | | |
| 2 | 5 | Example | 30 | — | — | — | 3 | 152 | Invention |
| | | Compound 4 | | | | | | | |
| 3 | 5 | Example | 30 | — | — | — | 3 | 152 | Invention |
| | | Compound 7 | | | | | | | |
| 4 | 5 | Example | 30 | — | — | — | 3 | 152 | Invention |
| | | Compound | | | | | | | |
| | | 11 | | | | | | | |
| 5 | 5 | Example | 20 | — | 10 | — | 3 | 152 | Invention |
| | | Compound | | | | | | | |
| | | 16 | | | | | | | |
| 6 | 5 | Example | 20 | — | — | 10 | 3 | 152 | Invention |
| | | Compound | | | | | | | |
| | | 17 | | | | | | | |
| 7 | 5 | Example | 20 | — | 5 | 10 | 3 | 152 | Invention |
| | | Compound | | | | | | | |
| | | 21 | | | | | | | |
| 8 | 5 | Celloxide | 30 | 70 | — | 10 | 3 | 152 | Comparative |
| | | 2021P | | | | | | | Example |

[Evaluation of Ink]

With respect to the ink basic materials, the manufactured inks and the printed matters obtained by the use thereof, the evaluation was carried out as follows.

(Stability of Epoxy Compound)

The dispersion state of the epoxy compound, the ink basic material after being stored at 100° C. for one month was evaluated by visual and viscosity changes with the following criteria.

A: No change in viscosity.

B: Increase in viscosity.

C: Occurrence of gelation.

(Safety of Epoxy Compound)

Irritative property when the ink adheres to skin was evaluated by the following criteria.

A: Nearly no change even when the ink adheres to skin.

B: Occurrence of rubefaction when the ink adheres to skin.

C: Occurrence of bulla when the ink adheres to skin.

(Stability of Ink)

The dispersion state of the ink after being stored at 25° C. for one month was evaluated by visual and viscosity changes with the following criteria.

A: No occurrence of precipitation and no change in viscosity.

B: No occurrence of precipitation and increase in viscosity.

C: Occurrence of precipitation.

(Safety of Ink)

Irritative property when the ink adheres to skin was evaluated by the following criteria.

A: Nearly no change even when the ink adheres to skin.

B: Occurrence of rubefaction when the ink adheres to skin.

C: Occurrence of bulla when the ink adheres to skin.

(Jetting Stability)

Continuous output for 30 min was performed at the printer having piezo heads, subsequently the presence or absence of clogging of the nozzle opening was observed, and the jetting stability was evaluated by the following criteria.

A: No occurrence of clogging of the nozzle opening by the continuous output for 30 min.

B: No occurrence of clogging but occurrence of satellites at the nozzle opening by the continuous output for 30 min.

C: Occurrence of clogging of the nozzle opening by the continuous output for 30 min.

(Curability)

Printing was performed on polyethylene terephthalate, a substrate using the inkjet printer having piezo heads, and subsequently, the cure was performed by an UV irradiation device (8 cold cathode tube lamps: power 20 W) at a feeding velocity of the substrate of 500 mm/sec under an environmental condition (temperature, humidity) shown in Table 2. Passing frequency of conveyer UV lamp until tackiness by finger touch was lost was measured.

(Film Strength)

Printing was performed on polyethylene terephthalate, a substrate using the inkjet printer having piezo heads, and subsequently, the cure was performed by an UV irradiation device (8 cold cathode tube lamps: power 20 W) at a feeding velocity of the substrate of 500 mm/sec under the condition at 25° C. and 45%. For the film strength, the strength of cured film was measured by a scratching with nail test, and evaluated by the following criteria.

A: The film is not peeled at all even when scratched

B: The film is slightly peeled when scratched strongly

C: The film is easily peeled when scratched.

(Adhesiveness)

With respect to the printing images made as is the case with the evaluation of the film strength, a sample where a printing face is not damaged and a sample where 11 cut lines were made in a vertical and horizontal directions respectively with intervals of 1 mm on the printing face to make 100 of grids with 1 mm square according to JIS K 5400 were made. An adhesive tape (R) was attached on each printing face and quickly peeled at an angle of 90°. The printing image or the grid state left without being peeled was evaluated by the following criteria.

A: Peeling of the printing image is not observed at all in the cross cut test.

B: Ink peeling is slightly observed in the cross cut test, but the peeling is scarcely observed unless the ink face is damaged.

C: Peeling by the adhesive tape (R) is easily observed in both conditions.

(Solvent Resistance and Water Resistance)

The printing image made as is the case with the evaluation of film strength was immersed in alcohol or warm water at 50° C. for 10 sec, and break and shrinkage of the image were visually evaluated by the following criteria to render solvent resistance and water resistance, respectively.

A: No change

B: Break and shrinkage occur slightly.

C: Break and shrinkage occur evidently. The result of the evaluations are shown in Table 2.

TABLE 2

| | Curability | | | | | | | | | | | | |
|---|---|---|---|---|---|---|---|---|---|---|---|---|---|
| | 25° C., | 25° C., | 35° C., | Stability | | | Safety | | | | | | |
| Ink | 45% | 85% | 85% | Epoxy | | | Epoxy | | Film | | Solvent | | |
| No. | RH | RH | RH | Compound | Ink | Jettability | Compound | Ink | Strength | Adhesiveness | Resistance | Durability | Note |
| 1 | 1 | 1 | 1 | A | A | A | A | A | A | A | A | A | Invention |
| 2 | 1 | 2 | 1 | A | A | A | A | A | A | A | A | A | Invention |
| 3 | 1 | 2 | 1 | A | A | A | A | A | A | A | A | A | Invention |
| 4 | 1 | 1 | 1 | A | A | A | A | A | A | A | A | A | Invention |
| 5 | 1 | 2 | 1 | A | A | A | A | A | A | A | A | A | Invention |
| 6 | 1 | 2 | 1 | A | A | A | A | A | A | A | A | A | Invention |
| 7 | 1 | 2 | 1 | A | A | A | A | A | A | A | A | A | Invention |
| 8 | 2 | 20 | 4 | B | B | C | B | B | C | C | B | C | Comparative |
| | | | | | | | | | | | | | Example |

From Table 2, it is evident that the present invention is more excellent than the comparison in stability and safety, curability, jetting stability, film strength, adhesiveness of printing image, and solvent resistance and water resistance of the printing image of the epoxy compound and the ink.

### Example 2

[Manufacture of Active Energy Ray Curable Compositions 1 to 10]

The materials shown in Table 3 except the cationic photopolymerization initiator were placed in a sand mill and dispersed for 4 hours to yield an active energy ray curable composition stock. Then, the cationic photopolymerization initiator shown in Table 3 was added to the stock, and gently mixed until the cationic photopolymerization initiator was dissolved. Subsequently, this was filtrated through a membrane filter by applying pressure to yield the active energy ray curable compositions 1 to 10 of the invention.

Respective compounds in the table 3 are shown below. Numerals represent parts by mass.

(Pigments)

P1: crude copper phthalocyanine (“Copper Phthalocyanine” supplied from Toyo Ink Mfg. Co., Ltd.) (250 parts), 2500 parts of sodium chloride and 160 parts of polyethyleneglycol (“Polyethyleneglycol 300” supplied from Tokyo Kasei Kogyo Cp., Ltd.) were placed in a styrene 1 gallon kneader (supplied from Inoue Manufacturing Co., Ltd.), and kneaded for 3 hours. Next, this mixture was put in 2.5 L of warm water, and stirred by a high speed mixer for about one hour with heating at about 8⁰° C. to make slurry. Subsequently, filtration and washing with water were repeated 5 times to eliminate sodium chloride and the solvent, and then drying was performed by spray-drying to yield the treated pigments.

(Oxetane Compound)

OXT 221: Oxetane ring-containing compound (supplied from Toagosei Co., Ltd.)

(Oxirane Compound)

CEL 2000: Epoxy compound (supplied from Daicel Chemical Industries, Ltd.)

(Vinylether Compound)

DVE-3: Triethyleneglycol divinyl ether (supplied from ISP).

(Pigment Dispersant)

Solsperse 32000: Aliphatic modification type dispersant (supplied from Zeneca Corporation)

(Cationic Photopolymerization Initiator)

SP-1: Triphenyl sulfonium salt (supplied from Asahi Denka Co., Ltd.)

SP-2: Triphenyl sulfonium salt (supplied from Asahi Denka Co., Ltd.)

SP-3: Triphenyl sulfonium salt (supplied from Asahi Denka Co., Ltd.) 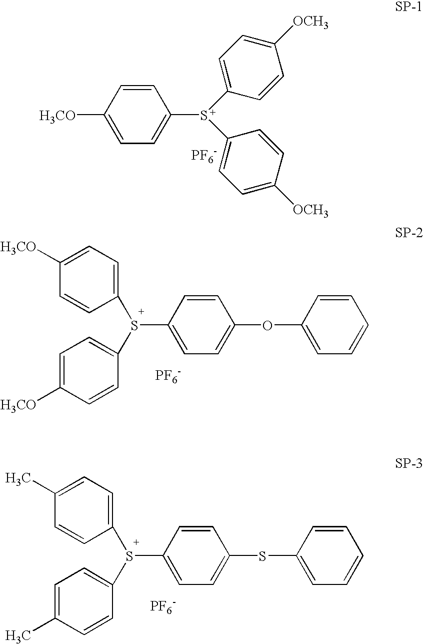
(Epoxy Compound)

Celloxide 3000 (molecular weight 168, (supplied from Daicel Chemical Industries, Ltd.)

TABLE 3

| | | | | | | | | Cationic | | |
|---|---|---|---|---|---|---|---|---|---|---|
| | | Epoxy Compound | | | | | | Photopolymerization | | |
| Ink | Amount of | | Molecular | | Amount of | Amount of | Amount of | Initiator | | |
| No. | P1 | Type | Weight | Amount | OXT221 | CEL2021P | DVE-3 | Type | Amount | Note |
| 1 | 5 | EP-9 | 338 | 15 | 65 | — | 10 | SP-1 | 5 | Invention |
| 2 | 5 | EP-12 | 352 | 20 | 70 | — | — | SP-1 | 5 | Invention |
| 3 | 5 | EP-17 | 380 | 20 | 70 | — | — | SP-2 | 5 | Invention |
| 4 | 5 | EP-31 | 340 | 20 | 70 | — | — | SP-2 | 5 | Invention |
| 5 | — | EP-35 | 366 | 10 | 70 | 10 | — | SP-3 | 10 | Invention |
| 6 | 5 | Celloxide | 168 | 15 | 65 | — | 10 | SP-1 | 5 | Comparative |
| | | 3000 | | | | | | | | Example |
| 7 | 5 | Celloxide | 168 | 20 | 70 | — | — | SP-1 | 5 | Comparative |
| | | 3000 | | | | | | | | Example |
| 8 | 5 | Celloxide | 168 | 20 | 70 | — | — | SP-2 | 5 | Comparative |
| | | 3000 | | | | | | | | Example |
| 9 | 5 | Celloxide | 168 | 20 | 70 | — | — | SP-2 | 5 | Comparative |
| | | 3000 | | | | | | | | Example |
| 10 | — | Celloxide | 168 | 10 | 70 | 10 | — | SP-3 | 10 | Comparative |
| | | 3000 | | | | | | | | Example |

With respect to the epoxy compound which is a basic material of the active energy ray curable composition (also referred to as the composition) and the manufactured active energy ray curable composition, the evaluation was carried out as follows.

(Safety of Epoxy Compound)

Irritative property when the ink adheres to skin was evaluated by the following criteria.

A: Nearly no change even when the ink adheres to skin.

B: Occurrence of rubefaction when the ink adheres to skin.

C: Occurrence of bulla when the ink adheres to skin.

(Stability of Composition)

The dispersion state of the composition after being stored at 25° C. for one month was evaluated by visual and viscosity changes with the following criteria.

A: No occurrence of precipitation and no change in viscosity.

B: No occurrence of precipitation and increase in viscosity.

C: Occurrence of precipitation.

(Safety of Composition)

Irritative property when the ink adheres to skin was evaluated by the following criteria.

A: Nearly no change even when the ink adheres to skin.

B: Occurrence of rubefaction when the ink adheres to skin.

C: Occurrence of bulla when the ink adheres to skin.

(Curability)

The cure was performed by the following five methods, and exposure energy until tackiness by finger touch was lost was measured. The lesser the exposure energy is, the better the curability is. The exposure energy is represented by relative values.

(Curing Method 1)

The composition was coated at a thickness of 10 μm on a bonderite steel plate with a size of thickness of 0.8 mm, width of 50 mm and length of 150 mm, and this was cured by passing under a condenser type high pressure mercury lamp of 80 W/cm at a location of 10 cm from the mercury lamp

(Curing Method 2)

The composition was cured as is the case with the curing method 1, except that the composition was coated at a thickness of 10 μm on a transparent polycarbonate plate.

(Curing Method 3)

The composition was coated at a coating amount of 1.0 g/m² on a surface-treated biaxial stretching polypropylene film with a film thickness of 30 μm using a coater and a surface-treated non-stretching polypropylene film with a thickness of 20 μm was bonded with pressure thereon. Subsequently it was cured as with the curing method 1.

(Curing Method 4)

The composition was coated at a thickness of 10 μm on art paper, and subsequently cured as with the curing method 1.

(Curing Method 5)

Using a three dimensional molding experimental system made up of a three dimensional NC (numerical value control) table on which a container for the composition was placed and a control section mainly including Ar laser (wavelength 333, 351 and 364 nm) and an optical system and a personal computer, a three dimensional molded matter with a width of 100 mm, a length of 100 mm and a thickness of 10 mm was obtained in design dimension by CAD from this composition by laminating at a pitch of 0.1 mm.

(Film Strength)

The strength of film cured at 25° C. and 45% RH was measured by a scratching with nail test, and the film strength was evaluated by the following criteria.

A: The film is not peeled at all even when scratched

B: The film is slightly peeled when scratched strongly

C: The film is easily peeled when scratched.

(Solvent Resistance and Water Resistance)

The sample made as is the case with the evaluation of film strength was immersed in alcohol or warm water at 50° C. for 10 sec., and break and shrinkage of the image were visually evaluated by the following criteria to render solvent resistance and water resistance, respectively.

A: No change

B: Break and shrinkage occur slightly.

C: Break and shrinkage occur evidently.

The results of the evaluations are shown in Table 4.

From Table 4, it is evident that the present invention is more excellent than the comparison in stability and safety, curability, film strength, solvent resistance and water resistance of the epoxy compound which is the basic material of the active energy ray curable composition and the active energy ray curable composition.

All of the disclosed contents including the specification, claims, drawings and abstract in Japanese Patent Application filed on Feb. 24, 2003, No. Tokugan-2003-045576 and all of the disclosed contents including the specification, claims, drawings and abstract in Japanese Patent Application filed on Jul. 23, 2003, No. Tokugan-2003-200385 compose parts of this application.

TABLE 4

| | | | | | Curability | | | | | |
|---|---|---|---|---|---|---|---|---|---|---|
| | Safety | | | Curing | 25° C., | 25° C., | 35° C., | | | |
| Composition | Epoxy | | | method | 45% | 85% | 85% | Film | Solvent | |
| No. | Compound | Composition | Stability | No. | RH | RH | RH | Strength | Resistance | Durability |
| 1 | A | A | A | 1 | 50 | 50 | 100 | A | A | A |
| 2 | A | A | A | 2 | 50 | 50 | 100 | A | A | A |
| 3 | A | A | A | 3 | 50 | 50 | 100 | A | A | A |
| 4 | A | A | A | 4 | 50 | 50 | 100 | A | A | A |
| 5 | A | A | A | 5 | 30 | 30 | 70 | A | A | A |
| 6 | C | B | C | 1 | 200 | 500 | 1000 | B | C | B |
| 7 | C | B | C | 2 | 200 | 500 | 1000 | B | C | B |
| 8 | C | B | C | 3 | 200 | 500 | 1000 | B | C | B |
| 9 | C | B | C | 4 | 200 | 500 | 1000 | B | C | B |
| 10 | C | B | C | 5 | 100 | 300 | 500 | B | C | B |

What is claimed is:

1. An active energy ray curable composition containing an epoxy compound having at least one oxirane ring having substituents at least at positions α and β of the oxirane ring, wherein the composition further containing either an oxetane compound or a vinylether compound.

2. The composition of claim 1, wherein the epoxy compound is represented by the following general formula (1) 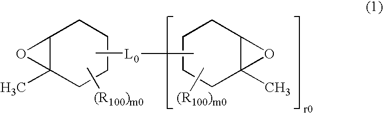
where R₁₀₀ represents a substituent, m0 represents 0 to 2, r0 represents 1 to 3, and L₀ represents an r0+1 valent linkage group with 1 to 15 carbons which may comprise oxygen or sulfur atoms in a backbone, or a single bond.

3. The composition of claim 1, wherein the epoxy compound is a compound represented by the following general formula (2) or (3): 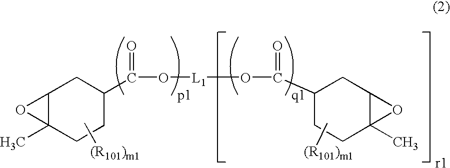
where R₁₀₁ represents a substituent, m1 represents 0 to 2, p1 and q1 represent 0 or 1, respectively, and r1 represents 1 to 3. L₁ represents an r1+1 valent linkage group with 1 to 15 carbons which may comprise oxygen or sulfur atoms in a backbone, or a single bond; 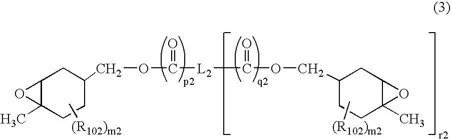
where R₁₀₂ represents a substituent, m2 represents 0 to 2, p2 and q2 represent 0 or 1, respectively, and r2 represents 1 to 3. L₂ represents an r2+1 valent linkage group with 1 to 15 carbons which may comprise oxygen or sulfur atoms in a backbone, or a single bond.

4. The composition of claim 1, wherein a molecular weight of the epoxy compound is from 170 to 1,000.

5. The composition of claim 1, further containing a cationic photopolymerization initiator.

6. The composition of claim 5, wherein the composition contains at least one sulfonium salt represented by the following formulae (4) to (7) as the cationic photopolymerization initiator, which does not produce benzene by irradiation of active energy ray, and a compound having oxetane ring as a photopolymerizable compound, 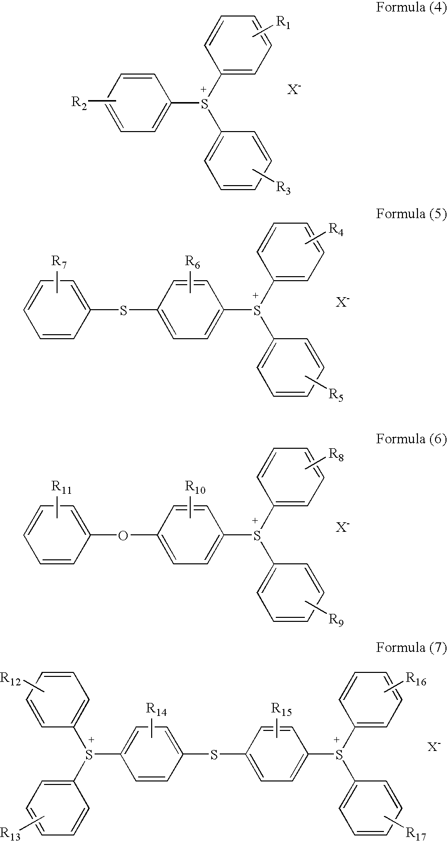
where each of R₁ to R₇ represents a hydrogen atom or a substituent, R₁ to R₃ do not represent hydrogen atoms simultaneously, R₄ to R₇ do not represent hydrogen atoms simultaneously R₈ to R₁₁ do not represent hydrogen atoms simultaneously, and R₁₂ to R₁₇ do not represent hydrogen atoms simultaneously, and X represents a non-nucleophilic anion residue.

7. The composition of claim 6, wherein the sulfonium salt represented by the above general formulae (4) to (7) is at least one of the sulfonium salts selected from the following general formulae (8) to (16), 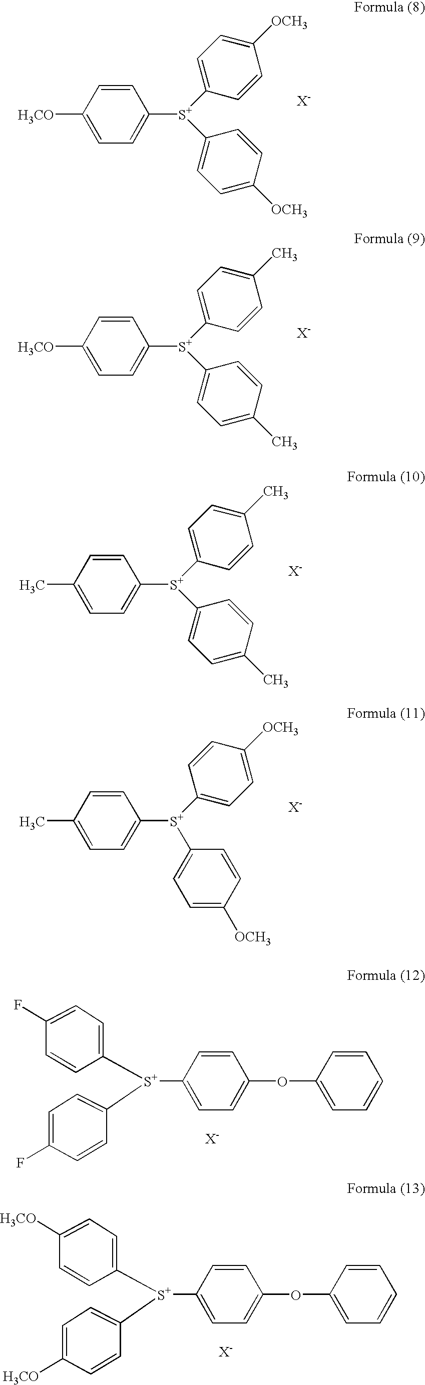 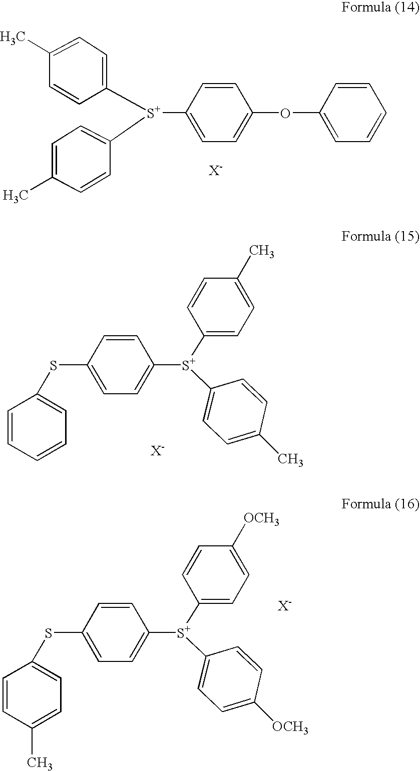
where X represents a non-nucleophilic anion residue.

8. The composition of claim 1, containing a pigment.

9. The composition of claim 1, wherein an average particle diameter of the pigment is from 10 to 150 nm.

10. The composition of claim 1, further containing a pigment dispersant.

11. The composition of claim 1, having a viscosity of 5 to 50 mPa·s at 25° C.

12. An active energy ray curable composition containing:
an epoxy compound having at least one oxirane ring having substituents at least at positions α and β of the oxirane ring; and
a cationic photopolymerization initiator;
wherein the composition contains at least one sulfonium salt represented by the following formulae (4) to (7) as the cationic photopolymerization initiator, which does not produce benzene by irradiation of active energy ray, and a compound having oxetane ring as a photopolymerizable compound, 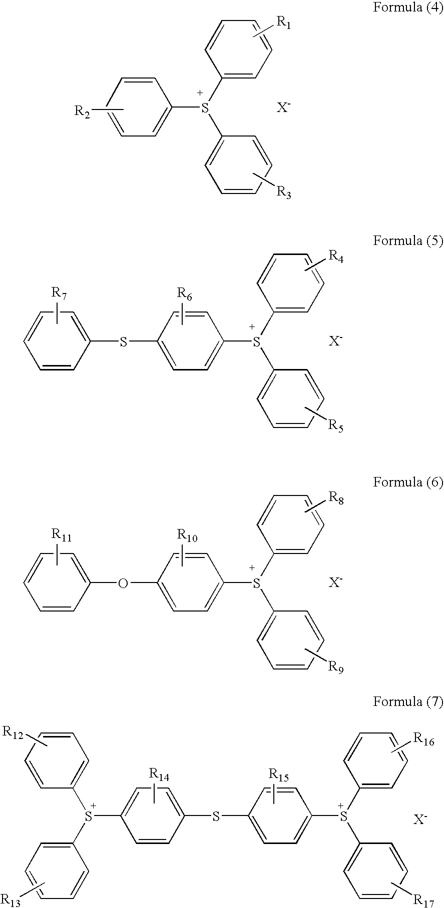
where each of R₁ to R₇ represents a hydrogen atom or a substituent, R₁ to R₃ do not represent hydrogen atoms simultaneously, R₄ to R₇ do not represent hydrogen atoms simultaneously, R₈ to R₁₁ do not represent hydrogen atoms simultaneously, and R₁₂ to R₁₇ do not represent hydrogen atoms simultaneously, and X represents a non-nucleophilic anion residue.

13. The composition of claim 12, wherein the sulfonium salt represented by the above general formulae (4) to (7) is at least one of the sulfonium salts selected from the following general formulae (8) to (16), 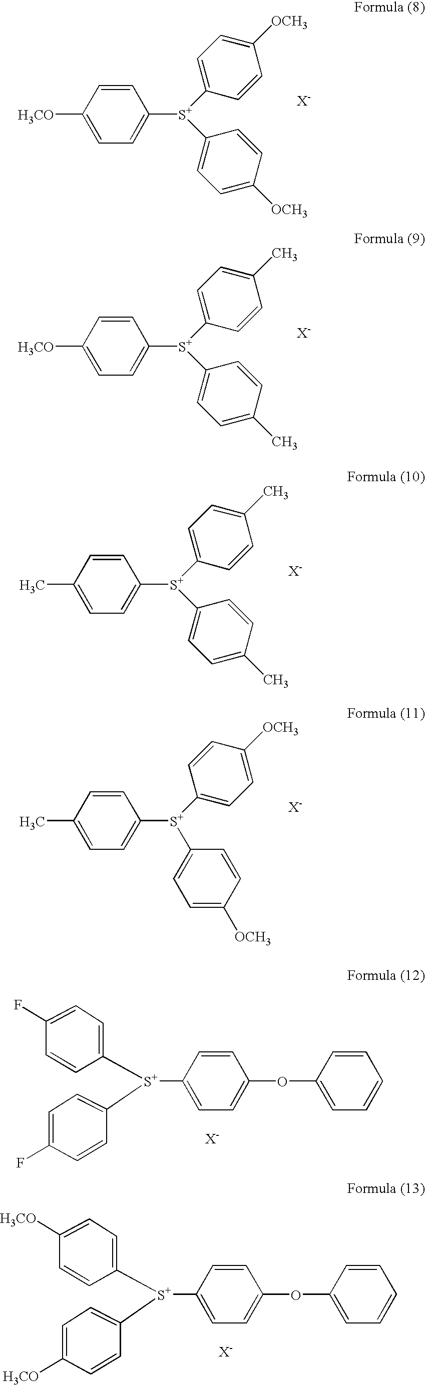 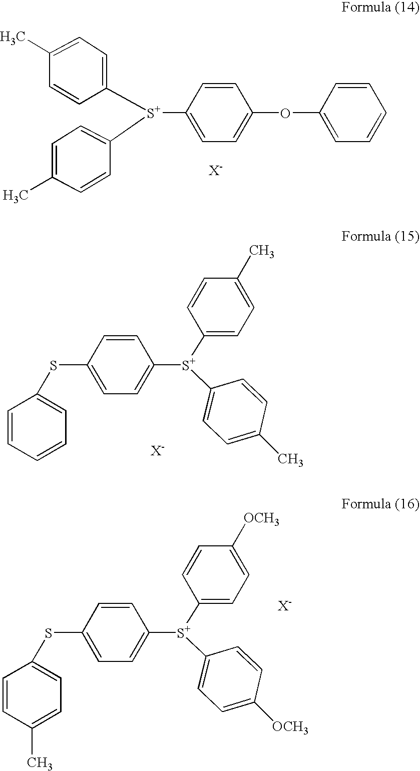
where X represents a non-nucleophilic anion residue.

14. The composition of claim 12, wherein the epoxy compound is represented by the following general formula (1): 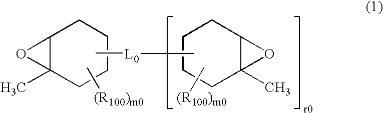
where R₁₀₀ represents a substituent, m0 represents 0 to 2, r0 represents 1 to 3, and L₀ represents an r0+1 valent linkage group with 1 to 15 carbons which may comprise oxygen or sulfur atoms in a backbone, or a single bond.

15. The composition of claim 12, wherein the epoxy compound is a compound represented by the following general formula (2) or (3): 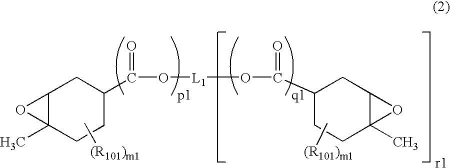
where R₁₀₁ represents a substituent, m1 represents 0 to 2, p1 and q1 represent 0 or 1, respectively, and r1 represents 1 to 3. L₁ represents an r1+1 valent linkage group with 1 to 15 carbons which may comprise oxygen or sulfur atoms in a backbone, or a single bond; 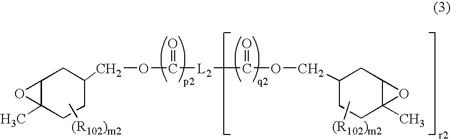
where R₁₀₂ represents a substituent, m2 represents 0 to 2, p2 and q2 represent 0 or 1, respectively, and r2 represents 1 to 3. L₂ represents an r2+1 valent linkage group with 1 to 15 carbons which may comprise oxygen or sulfur atoms in a backbone, or a single bond.

16. The composition of claim 12, wherein a molecular weight of the epoxy compound is from 170 to 1,000.

17. The composition of claim 12, containing a pigment.

18. The composition of claim 12, wherein an average particle diameter of the pigment is from 10 to 150 nm.

19. The composition of claim 12, further containing a pigment dispersant.

20. The composition of claim 12, having a viscosity of 5 to 50 mPa·s at 25° C.
